(19) United States
(12) Patent Application Publication
(10) Pub. No.: US 2026/0186874 A1
(43) Pub. Date: Jul. 2, 2026

(54) MULTI-TIER COMPUTE ARCHITECTURE

(71) Applicant: Openchip &Software Technologies S.L., Barcelona (ES)

(72) Inventors: Gaspar Mora Porta, Castellon de la Plana (ES); Edgar Gonzalez Pellicer, Girona (ES); Carlos Lopez, Barcelona (ES); Karol Weber, Valencia (ES); Francesc Guim Bernat, Barcelona (ES); Violante Moschiano, Avezzano (IT); Akira Tsukamoto, Barcelona (ES)

(21) Appl. No.: 19/043,062

(22) Filed: Jan. 31, 2025

Related U.S. Application Data
(63) Continuation of application No. PCT/EP2024/088657, filed on Dec. 30, 2024.

(51) Int. Cl. G06F 9/54; G06F 9/46; G06F 9/50

(52) U.S. Cl. CPC G06F 9/546; G06F 9/468; G06F 9/5094

(57) ABSTRACT

Systems, apparatus, articles of manufacture, and methods to implement multi-tier management architectures for compute devices are disclosed. An example apparatus disclosed herein includes a compute chiplet including a compute tile and a management tile, the management tile isolated from access by an operating system to be executed by the compute tile, and the management tile to at least one of control a feature of the compute tile or observe a state of the compute tile. The disclosed example apparatus also includes a management chiplet coupled with the compute chiplet, the management chiplet to discover the management tile, and obtain capability information that identifies one or more application programming interfaces (APIs) implemented by the management tile to at least one of control the feature of the compute tile or observe the state of the compute tile.

### STATEMENT REGARDING GOVERNMENT SUPPORT

The work leading to this invention has received funding from the European Union-Next Generation, Important Projects of Common European Interest (IPCEI). In particular, this invention was made with government support under Grant UNICO-IPCEI-2023-001 funded by the European Union-Next Generation IPCEI.

### RELATED APPLICATION(S)

This patent arises from a continuation of International Patent Application No. PCT/EP2024/088657, which was filed on Dec. 30, 2024. Priority to International Patent Application No. PCT/EP2024/088657 is claimed. International Patent Application No. PCT/EP2024/088657 is incorporated herein by reference in its entirety.

### FIELD OF THE DISCLOSURE

This disclosure relates generally to compute devices and, more particularly, to multi-tier management architectures for compute devices.

### BACKGROUND

Management architectures for compute devices enable users to observe and control devices for tasks such as performance monitoring (e.g., monitoring of processor utilization, memory utilization, operating temperature, etc.), power management (e.g., through clock frequency regulation, voltage regulation, etc.), service level assurance (e.g., through load balancing, resource activation/deactivation, etc.), etc.

### BRIEF DESCRIPTION OF THE DRAWINGS

FIG. 1 is a block diagram of an example system including example compute devices that implement a multi-tier management architecture in accordance with teachings of this disclosure.

FIG. 2 is a block diagram of an example compute chiplet included in the system of FIG. 1.

FIG. 3 is a block diagram of an example implementation of one of the compute devices included in the system of FIG. 1.

FIG. 4 illustrates example operations performed by an example management tile and an example management chiplet included in the system of FIG. 1.

FIG. 5 illustrates example implementations of the management tile and the management chiplet of FIG. 4.

FIG. 6 illustrates an example process flow performed by the management tile and the management chiplet of FIGS. 4 and/or 5.

FIG. 7 illustrates example implementations of the management tile and the management chiplet of FIG. 4 that include distributed artificial intelligence in an example multi-tier management architecture.

FIG. 8 illustrates example implementations of the management tile and the management chiplet of FIG. 4 that include centralized artificial intelligence in an example multi-tier management architecture.

FIGS. 9-13 illustrate further example systems that include the management chiplet and/or the management tile of FIGS. 1-8 to implement multi-tier management architectures in accordance with teachings of this disclosure.

FIG. 14 is a flowchart representative of example machine-readable instructions and/or example operations that may be executed, instantiated, and/or performed by example programmable circuitry to implement the example multi-tier management architecture of FIG. 1.

FIGS. 15-16 are flowcharts representative of example machine-readable instructions and/or example operations that may be executed, instantiated, and/or performed by example programmable circuitry to implement the example management tile of FIGS. 1-8.

FIGS. 17-18 are flowcharts representative of example machine-readable instructions and/or example operations that may be executed, instantiated, and/or performed by example programmable circuitry to implement the example management chiplet of FIGS. 1-8.

FIG. 19 is a block diagram of an example processing platform including programmable circuitry structured to execute, instantiate, and/or perform the example machine-readable instructions and/or perform the example operations of FIGS. 14-18 to implement the management chiplet and/or the management tiles of FIGS. 1-8.

FIG. 20 is a block diagram of an example implementation of the programmable circuitry of FIG. 19.

FIG. 21 is a block diagram of another example implementation of the programmable circuitry of FIG. 19.

FIG. 22 is a block diagram of an example software/firmware/instructions distribution platform (e.g., one or more servers) to distribute software, instructions, and/or firmware (e.g., corresponding to the example machine-readable instructions of FIGS. 14-18) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 23 illustrates an example hardware arrangement of an example data center.

FIG. 24A illustrates an example arrangement of an example chip assembly of FIG. 23

FIG. 24B illustrates an example arrangement of an example chip assembly of FIG. 23, adapted for high-performance computing applications.

In general, the same reference numbers will be used throughout the drawing(s) and accompanying written description to refer to the same or similar parts. The figures are not necessarily to scale.

### DETAILED DESCRIPTION

Many modern compute systems rely on management architectures that provide the capability to observe and/or control compute devices in operation. For example, a cloud computing facility may rely on a management architecture to monitor processor utilization, memory utilization, operating temperature, etc., for servers and/or data storage devices in the data center. Based on such monitoring, the cloud computing facility may rely on its management architecture to control the servers and/or data storage devices to perform power management, load balancing, resource activation/deactivation, etc., to meet service performance targets, resource utilization targets, failure rate targets, etc. As another example, a vehicular advanced driver assistance system (ADAS) may rely on a management architecture to observe and/or control compute devices in operation in the ADAS to ensure safety compliance targets are met, detect device failures, activate safety operating modes in response to detected and/or predicted failure conditions, etc. As yet another example, a factory robotic system may rely on a management architecture to observe and/or control compute devices in operation in the robotic system to monitor robotic function, adjust robotic operation, trigger shutdown in response to detected and/or predicted failure conditions, etc.

However, some management architectures rely on management software that executes on the compute device below a bare metal operating system (OS) of the device. Furthermore, in some such management architectures, the management software is accessible by the bare metal OS of the compute device, and may be accessible to a user of the compute device. As used herein, a bare metal OS refers to an OS that has access to the physical resources (e.g., hardware and/or firmware) of the compute device. In some examples, the bare metal OS corresponds to a host OS that executes on the compute device to provide applications with access to the physical resources of the compute device. In some examples, the bare metal OS is a physical OS that executes below a virtual OS on the compute device and that provides the virtual OS with access to the physical resources of the compute device.

However, there are several potential drawbacks to having the management software accessible by the bare metal OS. For example, if the security of the OS is comprised, the management software becomes vulnerable to side-channel attack and other security breaches. As another example, management software that is accessible by the bare metal OS may consume OS resources that could be allocated to other applications operating (e.g., executing) on the compute device. As yet a further example, if the OS fails, such management software may be inaccessible and, thus, unable to be used to resolve the failure. Moreover, some management architectures are static, monolithic architectures that are predicted on a fixed compute system design.

In contrast, example multi-tier management architectures disclosed herein provide management solutions tailored for advanced compute devices based on chiplets and/or other modular technologies that can be combined into a package. As used herein, a chiplet refers to any integrated circuit (IC) that has a modular structure designed to have one or more specified functionalities and to be combinable with other chiplets on an interposer or other substrate in a package. Examples of chiplets are compute chiplets that include processor circuitry (e.g., one or more processor circuits, such as one or more cores, etc.) and supporting circuitry (e.g., local memory, etc.) to provide processor functionality (e.g., to execute a host OS, applications, etc.), memory chiplets that include memory accessible to one or more other chiplets, communication chiplets that include communication interfaces (e.g., input/output hubs, networks, etc.) to enable other chiplets to communicate with each other and/or to other devices external to the package, etc. Example multi-tier management architectures provide a flexible management architecture that is multi-tiered to enable management of chiplet-based compute devices that include various combinations of chiplets from various manufacturers.

Furthermore, example multi-tier management architectures disclosed herein are based on management software and/or hardware solutions that are inaccessible to the bare metal OS that executes on the compute device. For example, some multi-tier management architectures disclosed herein include an example management chiplet that grants access to management capabilities (e.g., observing/monitoring capabilities and/or control capabilities, etc.) of the compute device. Furthermore, in some examples the management chiplet is not discoverable by the bare metal OS of the compute device and, thus, is not accessible by that OS. In some examples, the management chiplet provides an interface (e.g., which bypasses the bare metal OS of the compute device) to an authenticated, secure management system (also referred to as a secure management client) external to the compute device via which the secure management system can access the management capabilities (e.g., observing/monitoring capabilities and/or control capabilities, etc.) of the compute device.

Some example multi-tier management architectures disclosed herein also include management tiles that operate independently or in combination with the management chiplet to implement the management capabilities (e.g., observing/monitoring capabilities and/or control capabilities, etc.) of a particular chiplet in the compute device. As used herein, a tile refers to any IC that has a modular structure designed to have one or more specified functionalities and to be combinable with other tiles in a chiplet. For example, tiles can group one or more functional circuits into a single tile to implement a specified feature and/or group of features. Furthermore, tiles from different manufacturers can be combined into a given chiplet, and/or tiles can be replicated for inclusion in a given chiplet. Examples of tiles are compute tiles that include one or more processor circuits (e.g., cores) and supporting circuitry (e.g., local memory) to provide processor functionality (e.g., to execute a host OS, applications, etc.) in a chiplet, memory tiles that include memory accessible to one or more other tiles in the chiplet, memory controller tiles to control access to the memory tiles in the chiplets, etc.

For example, a given chiplet can include a respective management tile that implements the management capabilities (e.g., observing/monitoring capabilities and/or control capabilities, etc.) of that particular chiplet. In some examples, similar to the management chiplet, the management tile is not discoverable by the bare metal OS of the compute device and, thus, is not accessible by and, thus, is isolated from that OS. However, in some examples, the management tile is discoverable by the management chiplet such that the management chiplet can access the management tile to manage operation of its chiplet. Furthermore, in some examples, the management chiplet permits a secure management system (e.g., a secure management client) in communication with the management chiplet to access the management tile to manage operation of the chiplet associated with that management tile.

Also, example multi-tier management architectures that include example management tiles and/or example management chiplets disclosed herein may leverage different forms and/or levels of trust. Such different forms and/or levels of trust are also referred to herein as trust attributes. Such trust attributes can be utilized individually or in different combinations to achieve one or more overall trust goals associated with management of and/or operation of a compute device such as a tile and/or a chiplet.

For example, management tiles and/or management chiplets disclosed herein may implement one or more trust attributes related to device security (e.g., also referred to as device security trust attributes) to verify the authenticity and/or integrity of (e.g., to authenticate) one or more management tiles, one or more management chiplets and/or one or more other tiles and/or chiplets included in the compute device. Additionally or alternatively, example management tiles and/or management chiplets disclosed herein may implement one or more trust attributes related to client security (e.g., also referred to as client security trust attributes) to verify the authenticity and/or integrity of (e.g., to authenticate) one or more client devices, one or more of applications, etc., that request access to one or more of tiles and/or one or more of chiplets of the compute device. Additionally or alternatively, example management tiles and/or management chiplets disclosed herein may implement one or more trust attributes related to privilege verification (e.g., also referred to as privilege verification trust attributes) to verify that a tile, chiplet, client, etc., has appropriate authorization to be granted access to one or more features, one or more capabilities, one or more application programing interfaces (APIs), etc., provided by the tiles and/or chiplets of the compute device (e.g., corresponding to an approved set of features, capabilities, APIs). Additionally or alternatively, example management tiles and/or management chiplets disclosed herein may implement one or more trust attributes related to capability verification (e.g., also referred to as capability verification trust attributes) to verify that one or more features, one or more capabilities, one or more APIs, etc., provided by the tiles and/or chiplets of the compute device meet one or more expected advertised features, one or more capabilities, one or more APIs, etc., for those tiles and/or chiplets.

In some examples, the trust attributes associated with example management tiles and/or management chiplets disclosed herein are output as values, such as one or more numeric values, one or more text values, etc., that can be evaluated through one or more operations (e.g., comparisons, concatenations, summations, differences, etc.). For example, two or more different trust attributes can be combined to develop an overall trust value or score for an entity such as compute device, processor circuitry, a tile and/or a chiplet. In some examples, the values of individual trust attributes and/or different combinations of trust attributes can be used to develop several composite trust value(s) or score(s) (e.g., at different hierarchical levels) for the compute device, the processor circuitry, the tile and/or the chiplet.

Given the different forms of trust attributes provided by example tiles and/or chiplets disclosed herein, one or more of such trust attributes may also be referred to using other terminology. For example, trust attributes may also refer to as competence attribute(s) and/or compliance attribute(s) that quantify the suitability of features, capabilities, APIs, etc., provided by the tiles and/or chiplets for a given task or set of tasks (e.g., such as the competence and/or compliance of an artificial intelligence model obtained by and/or executed by a given tile and/or chiplet). In some examples, one or more trust attributes may be referred to as integrity attribute(s), assurance attribute(s), validation/validity attribute(s), privacy attribute(s), reliability attribute(s), credibility attribute(s), safety attribute(s), explainability attribute(s), trustworthiness attribute(s), etc.

Although example multi-tier management architectures are described herein in the context of chiplet-based compute device, the multi-tier management architectures disclosed herein are not limited thereto. On the contrary, example multi-tier management architectures can be used in other modular-based compute designs.

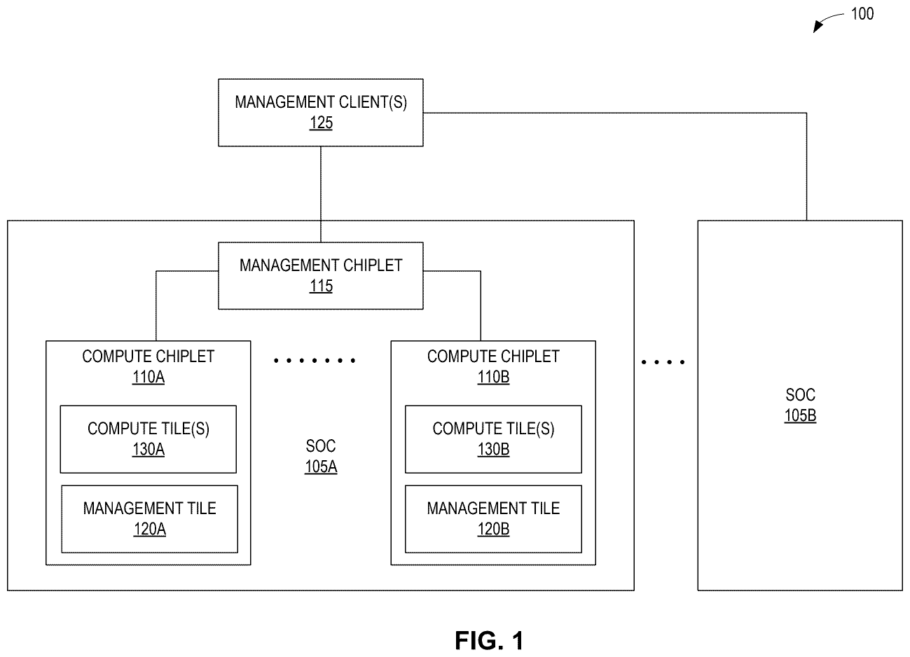

Turning to the figures, FIG. 1 is a block diagram of an example system 100 including example compute devices 105A-B that implement a multi-tier management architecture in accordance with teachings of this disclosure. In the illustrated example, the compute devices 105A-B are depicted as system-on-chip (SoC) devices. However, one or more of the compute devices 105A-B can be implemented by other types of compute devices, such as application specific integrated circuits (ASICs), semiconductor devices, chips, etc., or other types of compute devices. Furthermore, although two compute devices 105A-B are illustrated in FIG. 1, the system 100 can include fewer or more compute devices such as the compute devices 105A-B.

In the illustrated example of FIG. 1, the compute device 105A includes example compute chiplets 110A-B and an example management chiplet 115 coupled with the compute chiplets 110A-B. Also, the compute chiplets 110A-B include respective example management tiles 120A-B and respective example sets of one or more compute tiles 130A-B. Although the compute device 105A is depicted as including two compute chiplets 110A-B, the compute device 105A can include fewer or more compute chiplets 110A-B. In some examples, the compute device 105A can include other chiplet(s) in addition to, or in the alternative to, the compute chiplets 110A-B. For example, the compute device 105A can include one or more memory chiplets, communication chiplets, etc. Also, such other chiplet(s) can also include respective management tile(s) similar to the management tiles 120A-B. Furthermore, the various chiplets 110A-B and 115 can be homogeneous (e.g., implemented by the same manufacturer) or heterogeneous (e.g., with two or more of the various chiplets 110A-B and 115 implemented by distinct manufacturers).

The management chiplet 115 and/or the management tiles 120A-B of FIG. 1 may be instantiated (e.g., creating an instance of, bring into being for any length of time, materialize, implement, etc.) by programmable circuitry such as a Central Processor Unit (CPU) executing first instructions. Additionally or alternatively, the management chiplet 115 and/or the management tiles 120A-B of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

As disclosed above, the management tiles 120A-B implement the management capabilities (e.g., observing/monitoring capabilities and/or control capabilities, etc.) of their respective compute chiplets 110A-B in the compute device 105A. For example, the management tile 120A may perform power management associated with the compute tile(s) 130A included in the compute chiplet 110A, monitor utilization of one or more cores of the compute tile(s) 130A included in the compute chiplet 110A, monitor temperature of the core(s) of the compute tile(s) 130A included in the compute chiplet 110A, perform clock frequency regulation associated with the compute tile(s) 130A included in the compute chiplet 110A, perform voltage regulation associated with the compute tile(s) 130A included in the compute chiplet 110A, access telemetry associated with the compute tile(s) 130A included in the compute chiplet 110A, etc. In some examples, the management tile 120A implements one or more application programming interfaces (APIs) to control one or more features of the compute chiplet 110A and/or observe one or more states of the compute chiplet 110A.

In some examples, one or more of the management tiles 120A-B operate independently. For example, the management tile 120A may operate independently and autonomously and use its APIs to control feature(s) (e.g., characteristic(s), property or properties, circuit element(s), etc.) of a compute tile included in the compute chiplet 110A and/or observe state(s) of a compute tile included in the compute chiplet 110A. However, in some example, one or more of the management tiles 120A-B operate in combination with the management chiplet 115. For example, the management tile 120A may be coupled to and communicate with the management chiplet 115 and provide (e.g., grant) the management chiplet 115 access to one or more of its APIs to control feature(s) and/or observe state(s) of tiles included in the compute chiplet 110A.

As disclosed in further detail below, in some examples, the management chiplet 115 implements a discovery protocol to discover the management tiles 120A-B. In some such examples, after their discovery, the management chiplet 115 obtains respective capability information from the management tiles 120A-B that identifies one or more of the APIs implemented by the respective management tiles 120A-B to control feature(s) and/or observe state(s) of their corresponding compute chiplets 110A-B (e.g., such as the feature(s) and/or state(s) of the tiles included in their corresponding compute chiplets 110A-B). As disclosed in further detail below, in some examples, the management chiplet 115 also authenticates the management tiles 120A-B after the management tiles 120A-B are discovered. In some such examples, the management chiplet 115 stores results of the authentication of the management tiles 120A-B, and uses the stored authentication results to skip performing subsequent authentications of the management tiles 120A-B after a reboot of the compute device 105.

As disclosed in further detail below, in some examples, one or more of the management tiles 120A-B may also implement the discovery protocol to authenticate the management chiplet 115 and select the one or more APIs from a set of available APIs based on the authentication of the management chiplet 115. For example, the management tile 120A may evaluate a certificate and/or other access control information provided by the management chiplet 115 to select one or more APIs (e.g., a selected, approved subset of APIs that is permitted to be accessed by the management chiplet 115) from a set of available APIs implemented by the management tile 120A. The management tile 120A may then identify the selected one or more APIs (e.g., the approved subset of APIs) in the capability information provided to the management chiplet 115. In some such examples, the management tile 120A may further restrict the management chiplet 115 from access to other API(s) in the set of available APIs that were not selected based on the authentication of the management chiplet 115 (e.g., corresponding to a restricted set of APIs that is blocked/restricted from access by the management chiplet 115). In some examples, the management tile 120A stores a result of the authentication of the management chiplet 115 in persistent memory, and uses the stored authentication result to skip performing a subsequent authentication of the management chiplet 115 after a reboot of the compute device 105.

As disclosed above and in further detail below, the management tiles 120A-B are not discoverable and, thus, are not accessible by the bare metal OS of the compute device 105A (also referred to herein as the host OS of the compute device 105A). In other words, the management tiles 120A-B are isolated from the bare metal OS (or host OS) of the compute device 105A. In some examples, such isolation is achieved through the use of distinct memory address spaces. For example, the compute chiplets 110A-110B may include respective compute tiles, such as the respective sets of compute tiles 130A-130B, that include respective memories and processor circuitry to execute the bare metal OS (or host OS) of the compute device 105A. In some such examples, a management tile, such as the management tile 120A, may include its own memory and processor circuitry that is distinct from the memories and processor circuitry of those compute tiles. Furthermore, the memory of the management tile 120A may be associated with an address space that is distinct from the address spaces of the memories in the compute tiles 130A-130B of the respective compute chiplets 110A-110B. Through this distinct address space, the management tile 120A can be isolated from access by the bare metal OS (or host OS) executing on the compute tiles 130A-130B of the compute chiplets 110A-110B.

Likewise, and as disclosed above and in further detail below, the management chiplet 115 is not discoverable and, thus, is not accessible by the bare metal OS (or host OS) of the compute device 105A. In other words, the management chiplet 115 is isolated from the bare metal OS (or host OS) of the compute device 105A. In some examples, such isolation is also achieved through the use of distinct memory address spaces. For example, the management chiplet 115 may include its own memory and processor circuitry that is distinct from the memories and processor circuitry of the other chiplets, such as the chiplets 110A-B, in the compute device 105A. Furthermore, the memory of the management chiplet 115 may be associated with an address space that is distinct from the address spaces of the memories of the other chiplets, such as the chiplets 110A-B, in the compute device 105A. Through this distinct address space, the management chiplet 115 can be isolated from access by the bare metal OS (or host OS) executing on the compute tiles of the compute chiplets 110A-110B.

In the illustrated example of FIG. 1, the system 100 also includes one or more management clients 125 to provide local and/or remote management of the compute devices 105A-B. For example, the management client(s) 125 may be implemented by one or more management systems, one or more management applications and/or agents executing on compute device(s) (e.g., edge servers, network servers, cloud computing facilities, etc.) external to the compute devices 105A-B, etc. As also shown in the illustrated example, the management client(s) 125 communicate with the compute device 105A via the management chiplet 115. For example, the management client(s) 125 can provide user interface(s), such as graphical user interface(s), logging capability, etc., to provide any of the monitoring/observation and/or control features described above and in further detail below.

As disclosed in further detail below, in some examples, the management chiplet 115 communicates with a given management client 125 to authenticate the management client 125. After the management client 125 is authenticated, the management chiplet 115 provides the management client 125 with access to a set of one or more APIs to control and/or observe the management chiplet 115 itself and/or the compute chiplets 110A-B included in the compute device 105A. For example, the management chiplet 115 may implement a discovery protocol to obtain capability information from the management tiles 120A-B that identifies respective sets of APIs implemented by and to be used to access the corresponding ones of the management tiles 120A-B to manage their respective compute chiplets 110A-B. The management chiplet 115 may then provide access control information to the given management client 125, with the access control information to identify ones of the compute chiplets 110A-B and ones of the APIs that are accessible to the management client 125. In some examples, the management chiplet 115 determines the access control information based on its authentication of the management client 125 (e.g., based on a certificate and/or other authentication information provided by the management client 125).

As disclosed in further detail below, in some examples, the multi-tier management architecture implemented by the example system 100 of FIG. 1 also includes artificial intelligence (AI) processing capabilities. For example, the management chiplet 115 and/or the management tiles 120A-B may execute and/or otherwise implement one or more machine learning models, such as one or more neural networks, one or more regression models, one or more decision trees, etc., to manage features in the compute device 105A. Also, in some examples, the AI processing may be distributed in which the management tiles 120A-B respectively execute and/or otherwise implement machine learning models locally to control features of their respective compute chiplets 110A-B, with updates to the machine learning models managed by the management chiplet 115. However, in some examples, the AI processing may be centralized in which the management chiplet 115 executes and/or otherwise implements a machine learning model that uses observations provided by the management tiles 120A-B to control features of the compute chiplets 110A-B.

For example, and as disclosed in further detail below, the management tile 120A may observe the state of the compute tile(s) 130A included in the compute chiplet 110A and execute a machine learning algorithm to perform inference based on the observed state. The management tile 120A may then control a feature of the compute tile(s) 130A based on the inference performed by the machine learning algorithm. In some such examples, the management tile 120A may provide feedback associated with the execution of the machine learning algorithm to the management chiplet 115, and also obtain an update to the machine learning algorithm from the management chiplet 115. In some examples, the management tile 120 may also authenticate the machine learning algorithm before permitting the machine learning algorithm to be executed.

As another example, and as disclosed in further detail below, the management chiplet 115 may use one or more of the APIs provided to it by the management tile 120A to access the management tile 120A to observe a state of the compute tile(s) 130A included in the compute chiplet 110A. In some such examples, the management chiplet 115 executes a machine learning algorithm to perform inference based on the observed state. In some such examples, the management chiplet 115 further uses the one or more APIs provided to it by the management tile 120A to access the management tile 120A to control a feature of the compute tile(s) 130A based on the inference performed by the machine learning algorithm. In some examples, the management chiplet 115 may also authenticate the machine learning algorithm before permitting the machine learning algorithm to be executed.

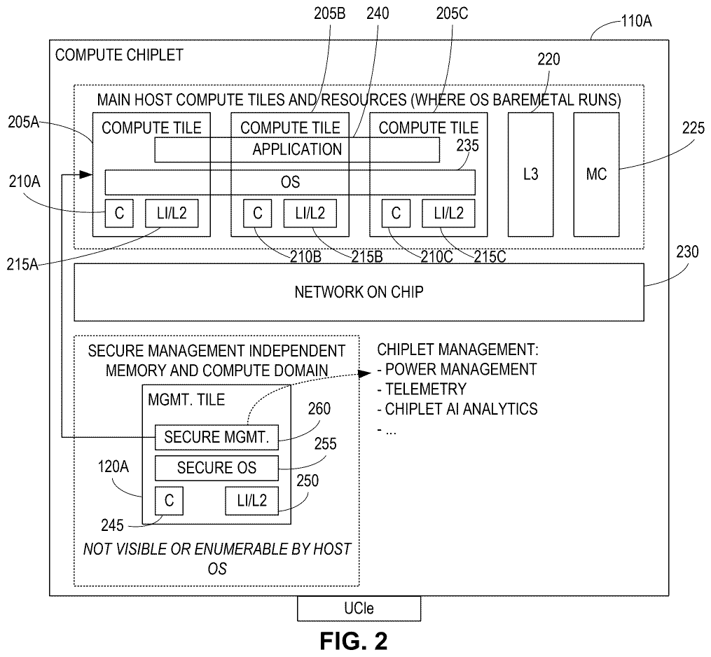

FIG. 2 is a block diagram of the example compute chiplet 110A included in the compute device 105A of FIG. 1. FIG. 2 also illustrates an example implementation of the management tile 120A included in the compute chiplet 110A. The compute chiplet 110A of FIG. 2 may be instantiated (e.g., creating an instance of, bring into being for any length of time, materialize, implement, etc.) by programmable circuitry such as a Central Processor Unit (CPU) executing first instructions. Additionally or alternatively, the compute chiplet 110A of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The compute chiplet 110A includes example compute tiles 205A-C. The example compute tiles 205A-C include respective example processor circuitry 210A-C and respective example memories 215A-C. The compute chiplet 110A also includes an example memory tile 220 and an example memory controller tile 225. The compute chiplet 110A further includes an example communication tile 230 that implements an on-device network (e.g., on-chip network) coupled to the other tiles 205A-C, 220 and 225 to permit the tiles to communicate with each other.

In the illustrates example, the compute tiles 205A-C (e.g., the respective processor circuitry 210A-C and the respective memories 215A-C) execute an example bare metal OS 235, also referred to as an example host OS 235. The host OS 235 is accessible to example application(s) 240 executing on the compute chiplet 110A. As such, the application(s) 240 may have access to any or all of the resources provided by the compute tiles 205A-C (e.g., including the respective processor circuitry 210A-C and respective memories 215A-C), the memory tile 220, the memory controller tile 225 and/or the communication tile 230. For example, the compute tiles 205A-C, the memory tile 220, the memory controller tile 225 and the communication tile 230 may be managed by the common OS 235 and be part of the same coherence domain.

As noted above, the example compute chiplet 110A of FIG. 2 also includes the management tile 120A. The management tile 120A includes example processor circuitry 245 and example memory 250. The processor circuitry 245 is distinct from the processor circuitry 210A-C and the memory 250 is distinct from the memories 215A-C. The management tile 120A (e.g., the processor circuitry 245 and the memory 250) executes an example secure OS 255 that is distinct from the host OS 235 of the compute chiplet 110A.

In the illustrated example, the management tile 120A is independent and not enumerable or discoverable by the host OS 235 running on compute chiplet 110A. Therefore, the management tile 120A is isolated from access by the host OS 235. In some examples, the management tile 120A has independent address and compute spaces such that the management tile 120A is not reachable from another tile in the compute chiplet 110A. For example, the processor circuitry 210A-C and the memories 215A-C of the compute tiles 205A-C may be associated with a common address space (e.g., that is part of the same coherence domain), whereas the processor circuitry 245 and the memory 250 of the management tile 120A may be associated with another address space that is distinct from that common address space.

In some examples, the management tile 120A provides a secure communication path, which can be network-based, based on a memory address shared space, etc., with other secure management agents in the compute device 105A containing the compute chiplet 110A. For example, the management tile 120A may provide a secure communication path with the management chiplet 115 in the compute device 105A. In some examples, the communication path is based on authentication to limit access to trusted management agents, such as the management chiplet 115, a secure, authenticated management client 125, etc. In some examples, the management tile 120A is included in the trusted platform module (TPM) flow of the compute device 105A and/or the system 100, which permits the management tile 120A to check and verify the integrity of the management tile 120A itself and/or other tiles in the compute chiplet 110A. For example, the management tile 120A can utilize the TPM flow to verify the integrity of the hardware, firmware and/or software of the management tile 120A to detect any unauthorized and/or improper changes. Additionally or alternatively, in some examples, the management tile 120A can utilize the TPM flow to verify the integrity of the hardware, firmware and/or software of the other tile(s) in the compute chiplet 110A that the management tile 120A is responsible for managing to detect any unauthorized and/or improper changes associated with those tile(s).

In the illustrated example, the management tile 120A executes example secure management software 260 on top of its secure management OS 255. The secure management software 260 provides a set of observability and management/control APIs, such as those described above, to permit control of feature(s) of the tile(s) included in the compute chiplet 110A and/or to permit observation of state(s) of the tile(s) included in the compute chiplet 110A. For example, the APIs can perform power management associated with the processor circuitry 210A-C of the compute tiles 205A-C, perform memory management associated with the memory circuitry 215A-C of the compute tiles 205A-C and/or the memory tile 220, obtain telemetry from one or more of the tiles 205A-C, 220, 225 and/or 230, support AI analytics associated with the compute chiplet 110A. etc. In some examples, the secure management software 260 has ring 0 or similar privileges to access the circuitry of the compute tiles 205A-C. In some examples, the management tile 120 authenticates the management software 260 before execution of the management software 260 is initiated, and prevents execution if authentication of the management software 260 is unsuccessful.

In the illustrated example, the management software 260 of the management tile 120A provides trusted management agent(s) in other parts of the compute device 105A, such as the management chiplet 115, with access to the APIs, or a subset thereof. In some examples, access to the management tile 120A is limited to trusted management agents within the boundaries of the compute device 105A including the compute chiplet 110A. In some such examples, the external access to the management tile 120A is limited to the management chiplet 115, and access originating from other external sources is blocked.

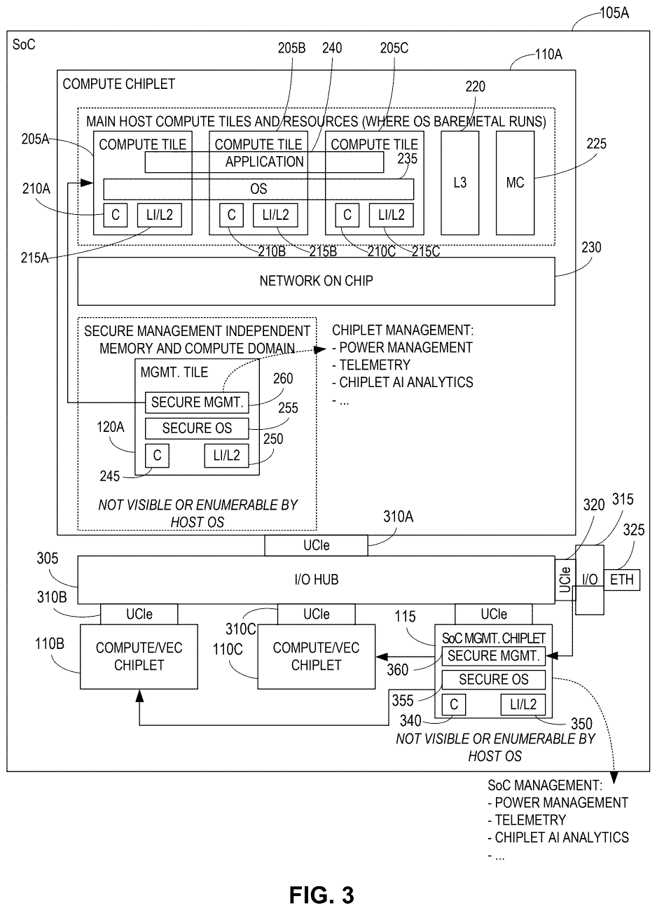

FIG. 3 is a block diagram of an example implementation of the compute device 105A included in the system 100 of FIG. 1. The example compute device 105A of FIG. 3 includes the example compute chiplet 110A of FIG. 2. FIG. 3 also illustrates an example implementation of the management chiplet 115 included in the compute device 105A. The compute device 105A of FIG. 3 may be instantiated (e.g., creating an instance of, bring into being for any length of time, materialize, implement, etc.) by programmable circuitry such as a Central Processor Unit (CPU) executing first instructions. Additionally or alternatively, the compute device 105A of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example compute device 105A of FIG. 3 includes the example compute chiplets 110A-B, as well as another example compute chiplet 110C. The compute device 105A of the illustrated example also includes an example internal communication chiplet 305. The internal communication chiplet 305 implements an example input/output (I/O) hub to interconnect the chiplets of the compute device 105A, including the compute chiplets 110A-C. For example, the internal communication chiplet 305 interconnects the compute chiplets 110A-C via example Universal Chiplet Interconnect Express™ (UCIe™) interface circuits 310A-C and/or other interconnect interface(s).

The compute device 105A of the illustrated example further includes an example external communication chiplet 315. The external communication chiplet 315 implements an example I/O hub to connect the chiplets of the compute device 105A with devices external to the compute device 105A. For example, the external communication chiplet 315 is coupled to the internal communication chiplet 305 via an example UCIe™ interface circuit 320 to enable the other chiplets of the compute device 105A to access the external communication chiplet 315 via the internal communication chiplet 305. The external communication chiplet 315 also includes an example network interface circuit 325, such as an example Ethernet transceiver 325, to communicate with devices external to the compute device 105A.

As noted above, the example compute device 105A of FIG. 3 includes the management chiplet 115. The management chiplet 115 includes example processor circuitry 345 and example memory 350. The processor circuitry 345 of the management chiplet 115 is distinct from the processor circuitry included in the compute chiplets 110A-C, such as the processor circuitry 210A-C of the compute chiplet 110A. Likewise, the memory 350 of the management chiplet 115 is distinct from the memories included in the compute chiplets 110A-C, such as the memories 215A-C of the compute chiplet 110A. The management chiplet 115 (e.g., the processor circuitry 345 and the memory 350) executes an example secure OS 355 that is distinct from the host OS 235 of the compute chiplets 110A-C.

In the illustrated example, the management chiplet 115 is independent and not enumerable or discoverable by the host OS 235 running on compute device 105A. Therefore, the management chiplet 115 is isolated from access by the host OS 235. In some examples, the management chiplet 115 has independent address and compute spaces such that the management chiplet 115 is not reachable from other chiplets in the compute device 105A. For example, the processor circuitry and the memories of the compute chiplets 110A-C may be associated with a common address space (e.g., that is part of the same coherence domain), whereas the processor circuitry 345 and the memory 350 of the management chiplet 115 may be associated with another address space that is distinct from that common address space.

In some examples, access to the management chiplet 115 is limited to external agents that are authenticated and trusted, such as a trusted management client 125. Also, in some examples, the management chiplet 115 restricts internal management operations to trusted, secure agents, such as the management tile 120A. To establish such trust, in some examples, the management chiplet 115 is part of the TPM flow from the perspective of the compute device 105A. Also, as described above, in some examples, the management chiplet 115 communicates with the management tile 120A via a secure communication path, which may be implemented via the internal communication chiplet 305.

For example, after the boot flow of the compute device 105A, the management chiplet 115 may discover and enumerate the respective management tiles in the chiplets present in the compute device 105A, such as the management tile 120A included in the compute chiplet 110A. In some such examples, the management chiplet 115 validates the respective proof of entity or the result of the authentication flow with each of the discovered and enumerated management tiles. If authentication of a management tile fails, the management chiplet 115 may disable the management tile and/or block access to the APIs implemented by that management tile.

In the illustrated example, the management chiplet 115, similar to the management tile 120A, executes example secure management software 360 on top of its secure management OS 355. The secure management software 360 is privileged and can monitor status, perform observability tasks (e.g., AI analysis of power versus performance, etc.), and carry out management/control actions associated with the various chiplets 110A-C, 305, 315, etc., via the APIs provided by their respective management tiles. In some examples, the management chiplet 115 authenticates the management software 360 before execution of the management software 360 is initiated, and prevents execution if authentication of the management software 360 is unsuccessful.

In the illustrated example, the management chiplet 115 also provides out-of-band APIs that can be used by external trusted and authenticated management clients, such as a management client 125, to access the APIs (or a subset thereof) provided by the management tiles of the various chiplets 110A-C, 305, 315, etc. In some examples, management clients 125 execute on-premises, in a data center, in a trusted cloud environment. etc. In some examples, the management chiplet 115 communicates with the manage client 125 over a secure communication path implemented via the external communication chiplet 315.

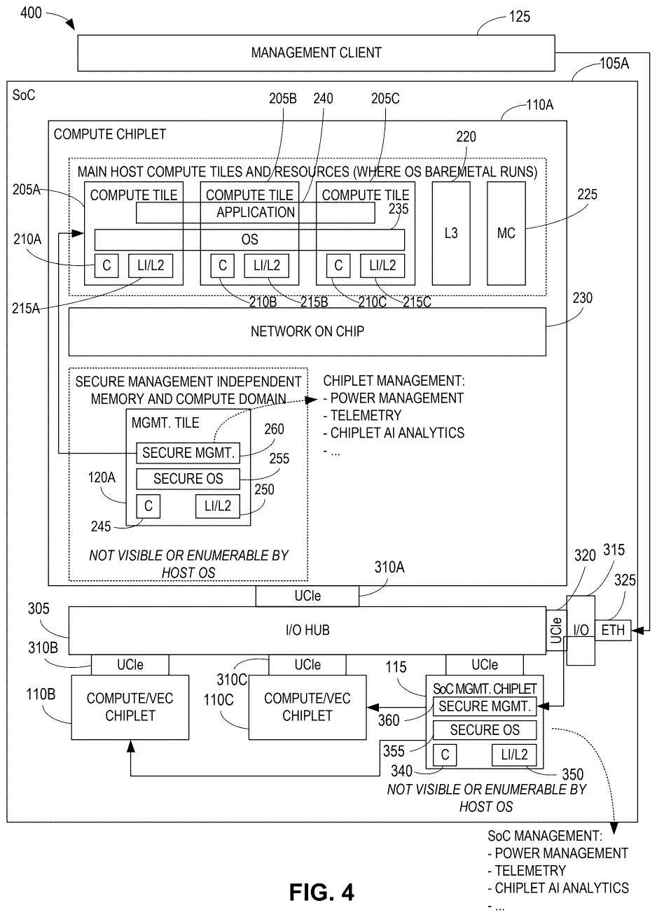

FIG. 4 illustrates example operations performed by the example management tile 120A and the example management chiplet 115 included in an example system 400 similar to the system 100 of FIG. 1. In the example of FIG. 4, the system 400 includes the example implementation of the compute device 105A illustrated in FIG. 3. The system 400 also includes a management client 125 operating outside the compute device 105A that is able to access, via the external communication chiplet 315, the observability and management features provided by the management chiplet 115.

In the illustrated example, the external management client 125 implements one or more authentication procedures to enable the management chiplet 115 to authenticate and validate connections with and requests from the management client 125 (e.g., an example of a client security trust attribute described above). Thus, the management chiplet 115 of the illustrated example implements functionality to contact a authentication server and/or other root of trust to the management client 125 and/or a particular device on which the management client 125 executes or is otherwise implemented.

In the illustrated example, the management chiplet 115 also determines which management privileges a particular authenticated management client 125 has relative to the particular compute device 105A (e.g., an example of a privilege verification trust attribute described above). For example, the management chiplet 115 may grant different management clients 125 access to different subsets of management APIs implemented the management tile 120A depending on the identity of the particular management client 125, access privileges associated with the particular management client 125, etc. For example, some management clients 125 may have access limited to observability APIs for the compute device 105A, whereas other management clients 125 may have access to management/control APIs, as well. As such, the management chiplet 115 may implement discovery procedures to determine which API(s) are available for a management client 125 with a particular identity. Examples of such APIs include (i) APIs that provide access to telemetry (e.g., power, resource consumption, thermals, etc.) of the compute device 105A and/or individual chiplets of the compute device 105A; (ii) APIs that provide access to static resources (e.g., type of memory, amount of memory, etc.) of the compute device 105A and/or individual chiplets of the compute device 105A; (iii) APIs that provide access to management features to enable or disable particular resources of the compute device 105A, (e.g., such as chiplets, cores, etc.); and (iv) APIs that provide access to features to activate or de-activate particular power features of the compute device 105A, such as a particular power control mode (e.g., efficient, AI based, etc.).

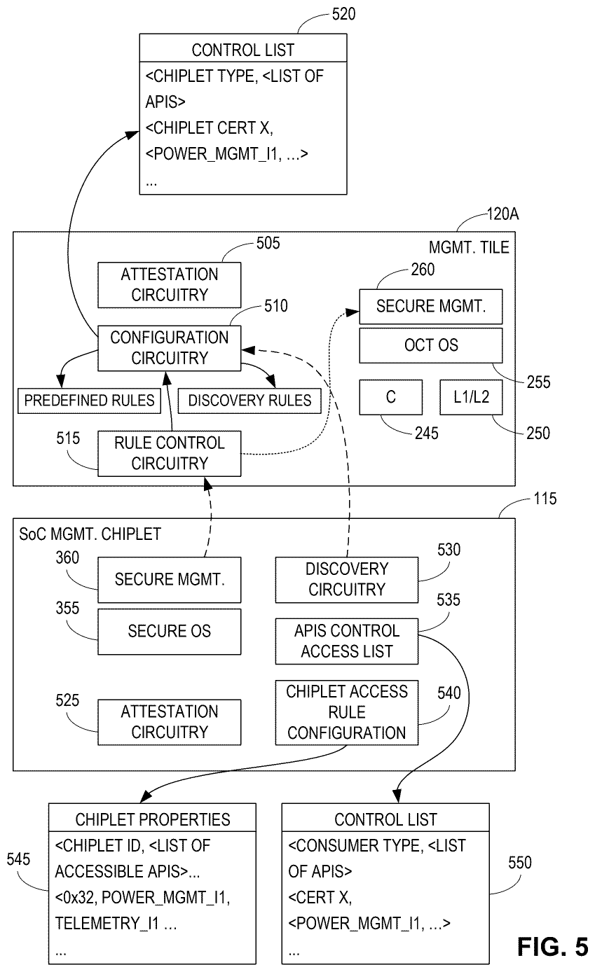

FIG. 5 illustrates additional example implementations of the management tile 120A and the management chiplet 115 that provide a management engine tailored for a chiplet-based architecture. As disclosed above, the management tile 120A includes the processor circuitry 245 and the memory 250. The management tile 120A also executes the secure management OS 255 and the secure management software 260. The management tile 120A of the illustrated example further includes example attestation circuitry 505, example configuration circuitry 510 and example rules control circuitry 515 to enhance security and speed of operation.

For example, after the system boots and the management chiplet 115 provides a proof of identify (e.g., an example of a device security trust attribute described above), the attestation circuitry 505 is responsible for connecting to an attestation service to validate the identity of the management chiplet 115. In the illustrated example, the configuration circuitry 510 is responsible for determining capability information that identifies which of the management tile's APIs the management chiplet 115 is permitted to access. For example, the capability information can be represented as an example control list 520. In some examples, the capability information is statically stored during manufacturing. In some examples, the capability information is dynamically discovered from a trusted external service.

In the illustrated example, the rules control circuitry 515 acts as a proxy for requests coming from the management chiplet 115 to the management tile 120A. Based on the capability information identified by the configuration circuitry 510, the management tile 120A will positively or negatively acknowledge requests to access particular APIs. If a particular request is positively acknowledged, the management tile 120A routes the request to the secure management software 260 to implement the particular features associated with the API(s) invoked by the request.

In the illustrated example, the management chiplet 115 includes the processor circuitry 345 and the memory 350, as described above. The management chiplet 115 also executes the secure OS 355 and the secure management software 360. The management chiplet 115 of the illustrated example further includes example attestation circuitry 525, example discovery circuitry 530, example access control circuitry 535, and example access rules configuration circuitry 540 to enhance security and speed of operation.

For example, the discovery circuitry 530 is responsible for discovering the various access APIs that respective management tiles, such as the management tile 120A, of various chiplets expose or make accessible to the management chiplet 115. In some examples, the particular APIs provided a management tile, such as the management tile 120A, may depend on the entity manufacturing or presenting the chiplet including that management tile. As such, different management tiles included in different chiplets may implement and expose different sets of APIs. In the illustrated example, the discovery circuitry 530 stores the results of its discover procedure(s) in an example chipset properties list 545.

In the illustrated example, the access control circuitry 535 implements procedures that allow external entities, such as the management client(s) 125, to discover which APIs are permitted to be accessed by those external entities, such as the management client(s) 125. In some examples, the access control circuitry 535 performs such discovery out-of-band and based on certificates associated with the entities, such as the management client(s) 125. In the illustrated example, the access control circuitry 535 stores the results of its discovery procedure(s) in an example control list 550. However, as described above, in some examples, the management chiplet 115 and the management tile 120A are not discoverable or otherwise accessible by the bare metal OS of the compute device 105A. Also, in some examples, access to the management chiplet 115 by external entities is limited to trusted external entities.

In the illustrated example, the access rule configuration circuitry 540 is used to ensure that requests sent to particular chiplets by the local software stack (e.g., in response to requests from external entities such as the management client(s) 125) are valid and consistent with the discovered APIs and any associated access rules stored in the chiplet properties list 545. In the illustrated example, the attestation circuitry 525 is responsible for attesting the various chiplets that it will manage. In this way, the attestation circuitry 525 can ensure the chiplets it manages are trustworthy and, in some examples, disable those chiplets for which attestation fails.

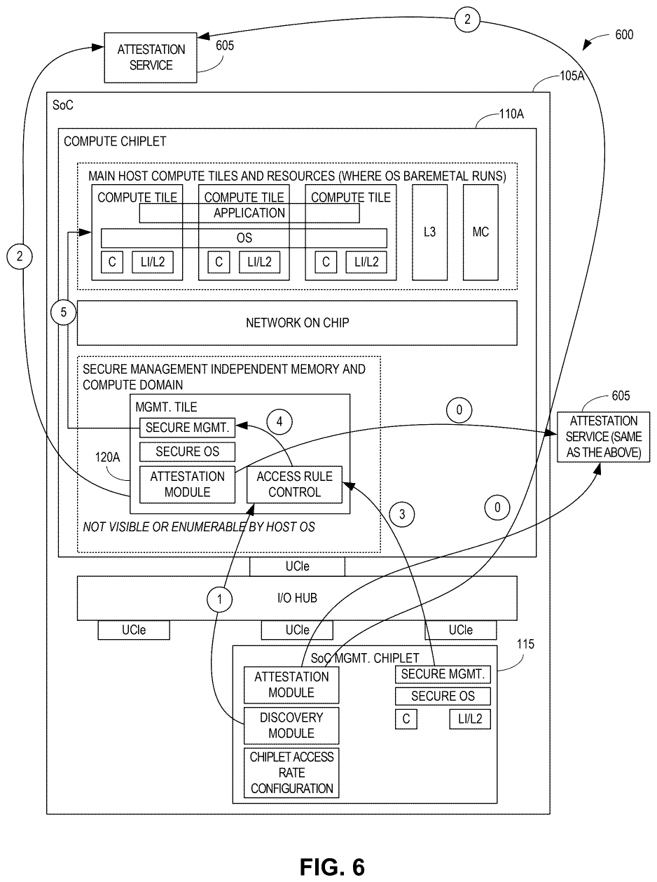

FIG. 6 illustrates an example process flow 600 performed by the management tile 120A and the management chiplet 115 of FIG. 4 in the compute device 105A of FIGS. 3 and/or 4. The example flow 600 begins at example operations 0 at which, after boot of the compute device 105A, the management tile 120A performs self-attestation with an example attestation service 605 and the management chiplet 115 performs self-attestation with the attestation service 605. At example operation 1, the management chiplet 115 performs a discovery procedure to discover the management tile 120A. At example operation 2, the management tile 120A authenticates management chiplet 115 with the attestation service 605, and the management chiplet 115 authenticates the management tile 120A with the attestation service 605. Assuming authentication is successful, the management tile 120A provides capability information to the management chiplet 115 that identifies API(s) implemented by the management tile 120 control/observe the tiles in the compute chiplet 110.

At example operation 3, the management chiplet 115 sends a request to the management tile 120A to invoke one or more of the APIs to control/observe the tiles in the compute chiplet 110. At example operation 4, the management tile 120A validates the request against any access control rule/limitations associated with the management chiplet 115 (e.g., determined during the discovery/authentication process). Assuming the request is valid, at example operation 5, the management tile 120A uses the invoked API(s) to control/observe the tiles in the compute chiplet 110.

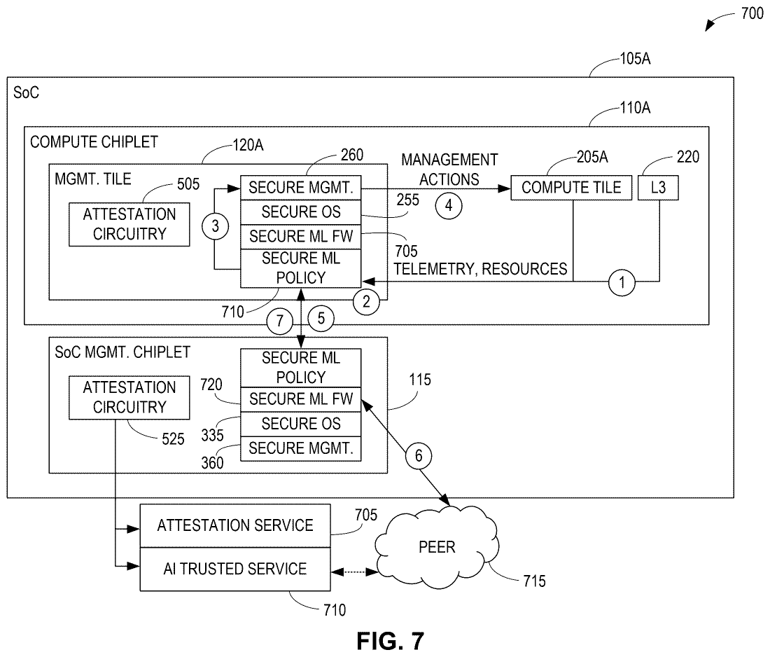

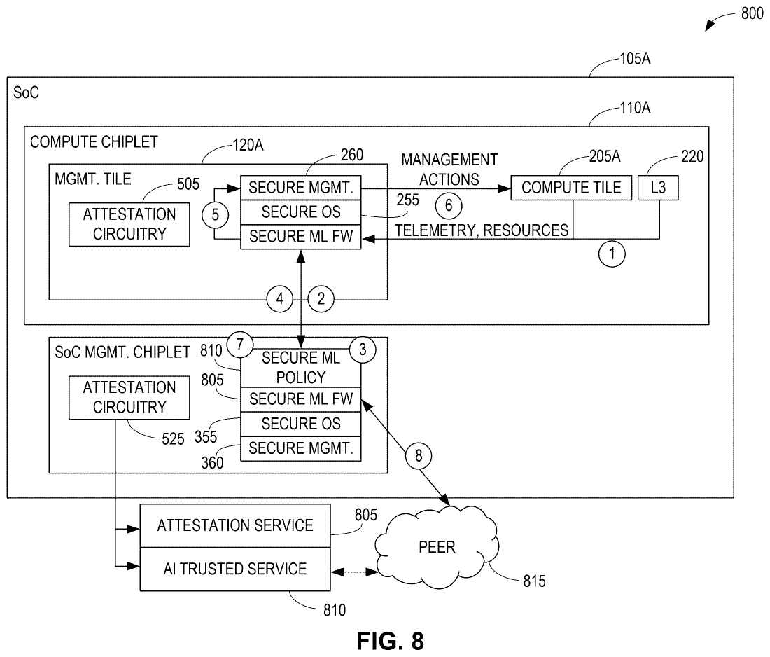

FIGS. 7 and 8 illustrate additional example implementations of the management tile 120A and the management chiplet 115 that include AI in an example multi-tier management architecture. Due to its position as a supervisor of management tiles, such as the management tile 120A, in other chiplets, the management chiplet 115 can coordinate AI-based policies for management. Such AI-based policies can use the dynamic telemetry and the static resource configuration of chiplets in the compute device 105A as features to be inferred by AI algorithms, such as machine learning models, to make management decisions. Examples of such management decisions include, but are not limited to, turning components and/or features on/off, changing operating parameters (e.g., core frequencies), using particular resources among a class of resources (e.g., different memories or storage with different properties to avoid wear-off), etc.

Multiple AI configurations are possible in terms of the location of model execution and how the models are updated. For example, machine learning models can be executed by the individual management tiles of individual chiplets in a distributed configuration. In some such examples, machine learning models executed by the individual management tiles can incorporate information from other chiplets mediated through the management chiplet. In some such examples, local update of these per-chiplet machine learning modes is based on reinforcement learning.

In some examples, a centralized machine learning model can be executed by the management chiplet using aggregated feedback provided by the management tiles across the various chiplets. In some such examples, local update of this centralized machine learning model is based on reinforcement learning using aggregated feedback from the various chiplets.

In some example, remote updates to the machine learning model(s) executed by the management tiles and/or the management chiplet can be provided by a secure service under a subscription model. In some examples, federated learning of the machine learning model(s) provided by the secure service can be based on per-chiplet or per-device gradients (e.g., to improve the machine learning model(s)). Also, due to the availability of attestation capabilities, the machine learning models executed by the management tiles and/or the management chiplet can be authenticated before execution.

FIG. 7 illustrates an example implementation 700 of the management tile 120A and the management chiplet 115 that provides a distributed AI multi-tier management architecture in the compute device 105A. In the illustrated example, the compute device includes the compute chiplet 110A and the management chiplet 115. The compute chiplet includes the management tile 120A, the compute tile 205A and the memory tile 220. The management tile 120A includes the attestation circuitry 505 and executes the secure management OS 255 and the secure management software 260. The management chiplet 115 includes the attestation circuitry 525 and executes the secure management OS 355 and the secure management software 360. In the illustrated example, the management tile 120A and the management chiplet 115 implement a distributed AI management framework as follows.

At example operation 1, information about the dynamic state and static properties of the elements in the compute chiplet 110A (e.g., the compute tiles 205A, the memory tile 220, etc.) is made available to the management tile 120A associated with the compute chiplet 110A.

At example operation 2, the management tile 120A uses the information as input features to an example machine learning model 705 that computes an example management policy 710.

At example operation 3, the management tile 120A routes the management policy 710 output from the machine learning model 705 to the management APIs implemented by the secure management software 260 for the compute chiplet 110A.

At example operation 4, the management APIs implemented by the secure management software 260 act on the chiplet elements to implement the learned management policy 710.

At example operation 5, the machine learning model 705 is also refined using reinforcement learning. This can happen in an independent manner in the given chiplet 110A and/or coordinated by the central management chiplet 115. In some examples, the machine learning model 705 is refined using federated learning for increased data protection.

In some examples, at operation 6, federated learning also occurs at remote peers 715. In the illustrated example, the federated learning leverages the trust provided by one or more example attestation and/or trust services 705-710, as shown.

In some such examples, at operation 7, after federation with remote peers, the central management chiplet 115 can distribute example machine learning model updates 720 to the individual management tiles, such as the management tile 120A.

FIG. 8 illustrates an example implementation 800 of the management tile 120A and the management chiplet 115 that provides a centralized AI multi-tier management architecture in the compute device 105A. In the illustrated example, the compute device includes the compute chiplet 110A and the management chiplet 115. The compute chiplet includes the management tile 120A, the compute tile 205A and the memory tile 220. The management tile 120A includes the attestation circuitry 505 and executes the secure management OS 255 and the secure management software 260. The management chiplet 115 includes the attestation circuitry 525 and executes the secure management OS 355 and the secure management software 360. In the illustrated example, the management tile 120A and the management chiplet 115 implement a centralized AI management framework as follows.

In the illustrated example, an example machine learning model 805 executes at the central management chiplet 115.

At example operation 1, information about the dynamic state and static properties of the elements in the compute chiplet 110A (e.g., the compute tiles 205A, the memory tile 220, etc.) is made available to the management tile 120A associated with the compute chiplet 110A.

At example operation 2, the management tile 120A forwards this information to the management chiplet 115.

At operation 3, the management chiplet 115 uses the information as input features for the central machine learning model 805, which computes an example management policy 810.

At example operation 4, the management chiplet 115 routes the management policy 810 output from the machine learning model 804 back to the management tile 120A of the chiplet 110A.

At example operation 5, the management tile 120A routes the management policy 810 forwarded to the management APIs implemented by the secure management software 260 for the compute chiplet 110A.

At example operation 6, the management APIs implemented by the secure management software 260 act on the chiplet elements to implement the learned management policy 810.

At example operation 7, the machine learning model 705 is also refined using reinforcement learning within the central management chiplet 115.

In some examples, at operation 8, federated learning also occurs at remote peers 815. In the illustrated example, the federated learning leverages the trust provided by one or more example attestation and/or trust services 805-810, as shown.

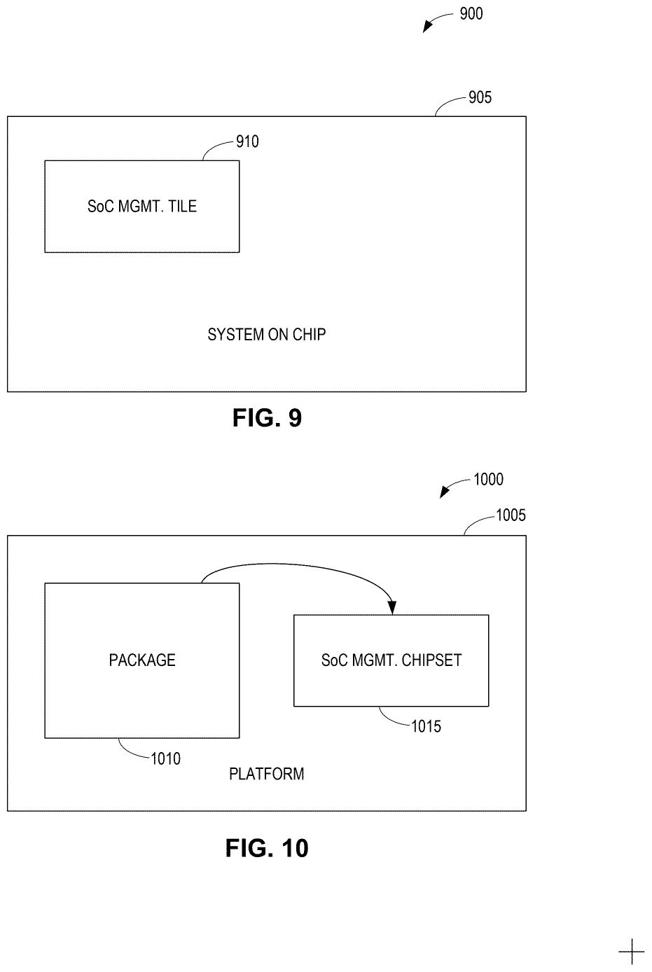

FIGS. 9-13 illustrate further example systems that implement multi-tier management architectures in accordance with teachings of this disclosure. FIG. 9 illustrates an example system 900 including an example compute device 905 that includes an example management tile 910. In the illustrated example, the management tile 910 implements management functionality for the compute device 905 in isolation.

FIG. 10 illustrates an example system 1000 including an example compute platform 1005. The compute platform 1005 includes an example compute device 1010 coupled to an example management chiplet 1015 external to the compute device 1010. In the illustrated example, the management chiplet 1015 implements management functionality for the compute device 1010 in isolation.

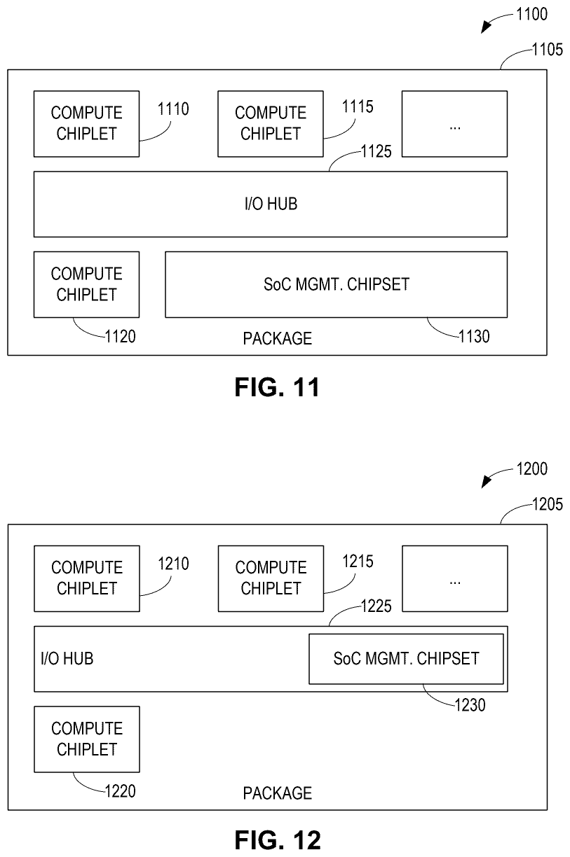

FIG. 11 illustrates an example system 1100 including an example compute device 1105. The compute device 1105 includes example compute chiplets 1110-1120, an example communication chiplet 1125 and an example management chiplet 1130. In the illustrated example, the management chiplet 1130 communicates with example management tiles in the compute chiplets 1110-1120 to implement management functionality for the compute device 1105.

FIG. 12 illustrates an example system 1200 including an example compute device 1205. The compute device 1205 includes example compute chiplets 1210-1220, an example communication chiplet 1225 and an example management chiplet 1230. In the illustrated example, the management chiplet 1130 is integrated into the communication chiplet 1225. The management chiplet 1230 communicates with example management tiles in the compute chiplets 1110-1120 to implement management functionality for the compute device 1105.

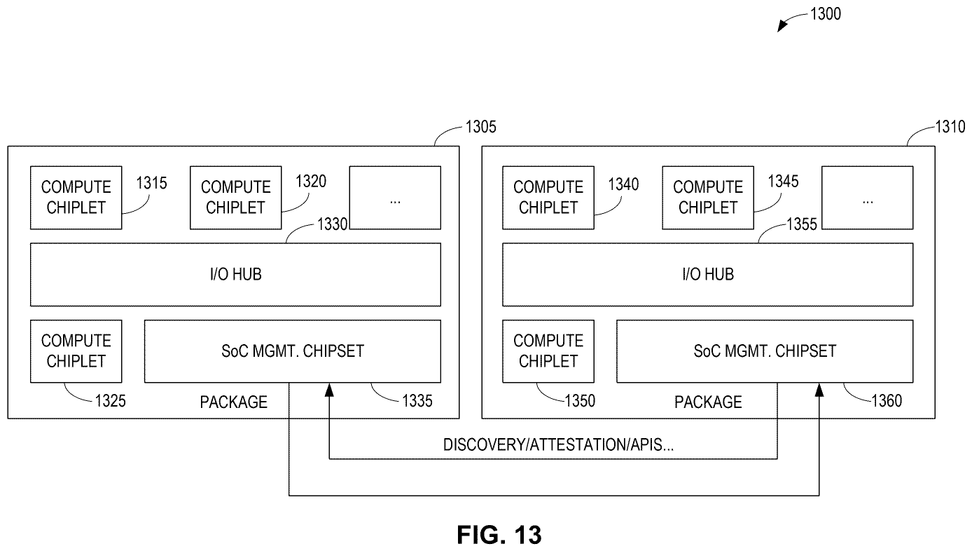

FIG. 13 illustrates an example system 1300 including an example compute device 1305 and an example compute device 1310. The compute device 1305 includes example compute chiplets 1315-1325, an example communication chiplet 1330 and an example management chiplet 1335. The compute device 1310 includes example compute chiplets 1340-1350, an example communication chiplet 1355 and an example management chiplet 1360. In the illustrated example, the management chiplet 1335 communicates with example management tiles in the compute chiplets 1315-1325 to implement management functionality for the compute device 1305. In the illustrated example, the management chiplet 1360 communicates with example management tiles in the compute chiplets 1340-1350 to implement management functionality for the compute device 1310. In the illustrated example, the management chiplet 1335 and the management chiplet 1360 also communicate with each other to implement management functionality collectively across the compute device 1305 and the compute device 1310.

The systems 900-1300 include the attestation procedures, discovery flows, etc., described above. Also, in the system 1300 with multiple management chiplets 1335 and 1360, management flows occur between the management chiplets 1335 based on several possible topologies. For example, one management chiplet may act as a primary management chiplet and the other may act as a secondary management chiplet. As another example, the management chiplets 1335 may operate peer-to-peer flows between the chiplets and work together but not accept management API calls from other chiplets. As another example, there may be no cooperation among the management chiplets 1335.

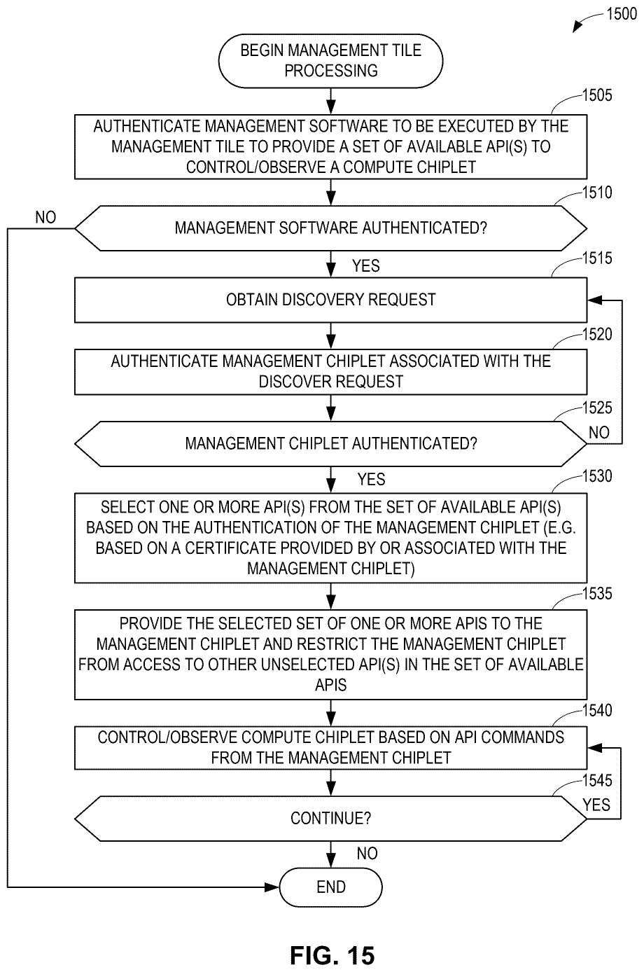

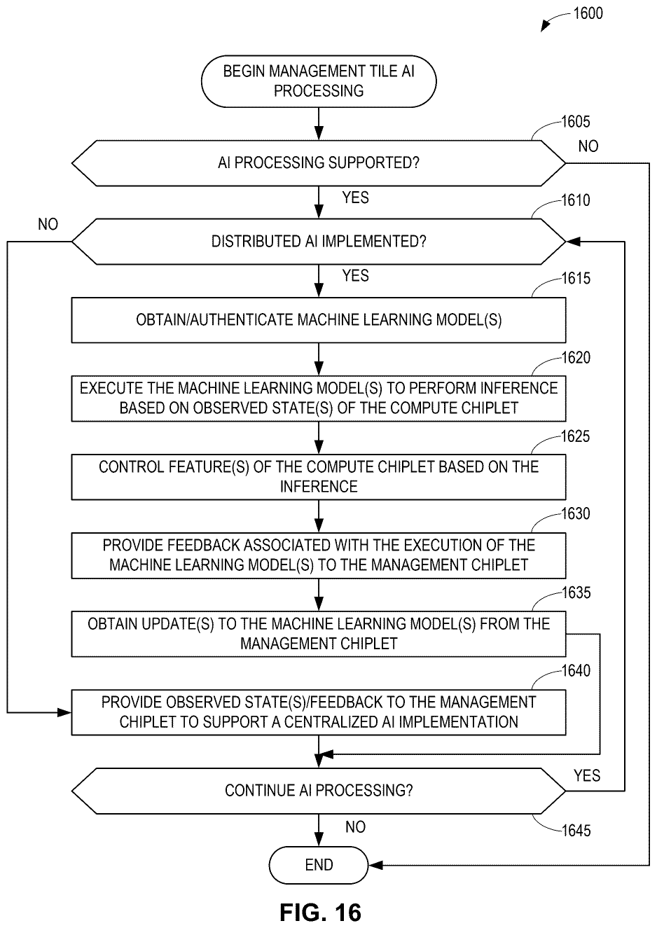

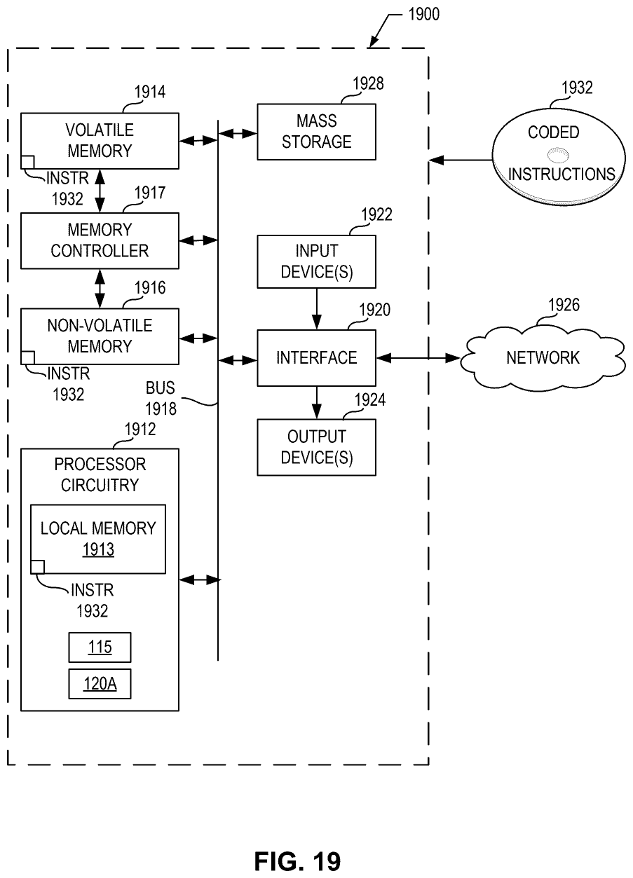

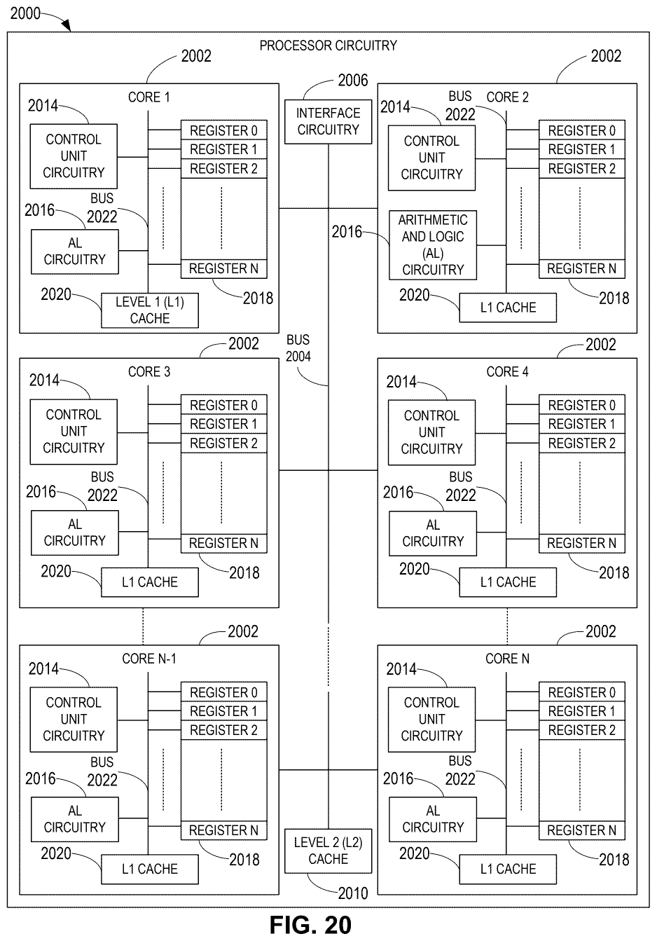

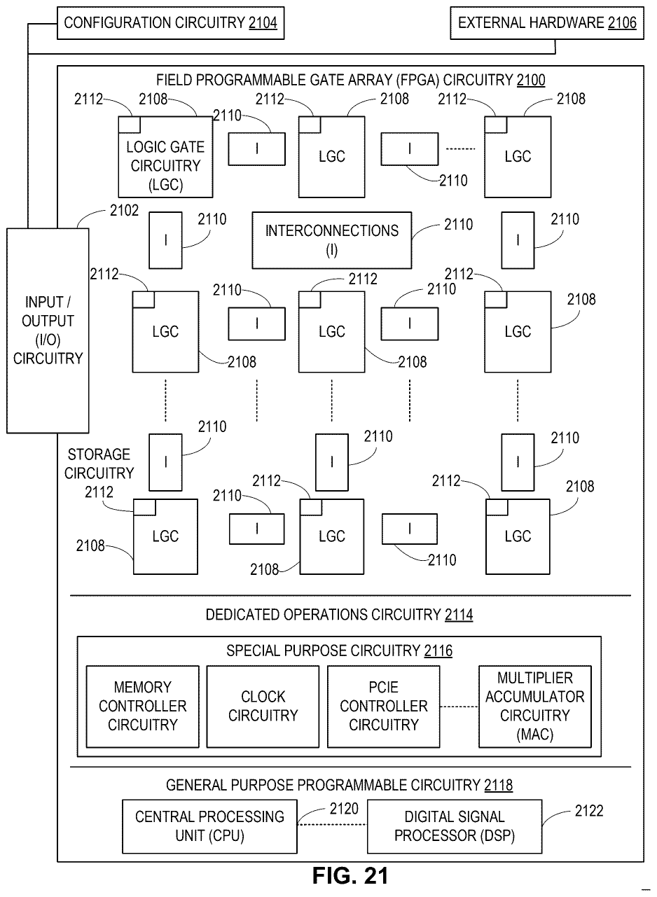

In some examples, the compute device 105A includes means for managing a single chiplet in the compute device 105A. For example, the means for managing the single chiplet may be implemented by the management tile 120A. In some examples, the management tile 120A may be instantiated by programmable circuitry such as the example programmable circuitry 1912 of FIG. 19. For instance, the management tile 120A may be instantiated by the example microprocessor 2000 of FIG. 20 executing machine executable instructions such as those implemented by at least blocks 1505-1545 of FIG. 15 and/or blocks 1605-1645 of FIG. 16. In some examples, the management tile 120A may be instantiated by hardware logic circuitry, which may be implemented by an ASIC, XPU, or the FPGA circuitry 2100 of FIG. 21 configured and/or structured to perform operations corresponding to the machine-readable instructions. Additionally or alternatively, the management tile 120A may be instantiated by any other combination of hardware, software, and/or firmware. For example, the management tile 120A may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

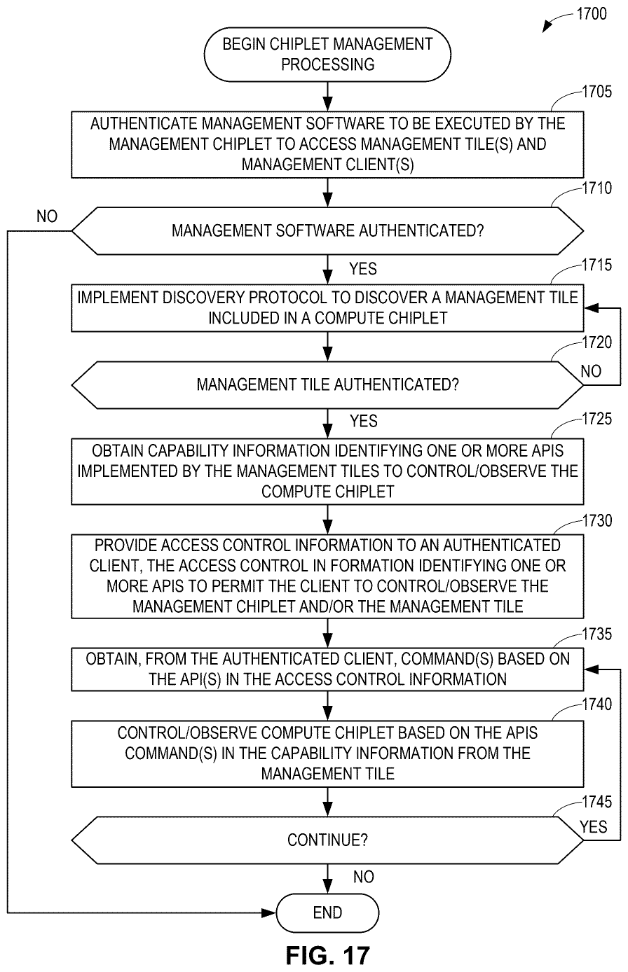

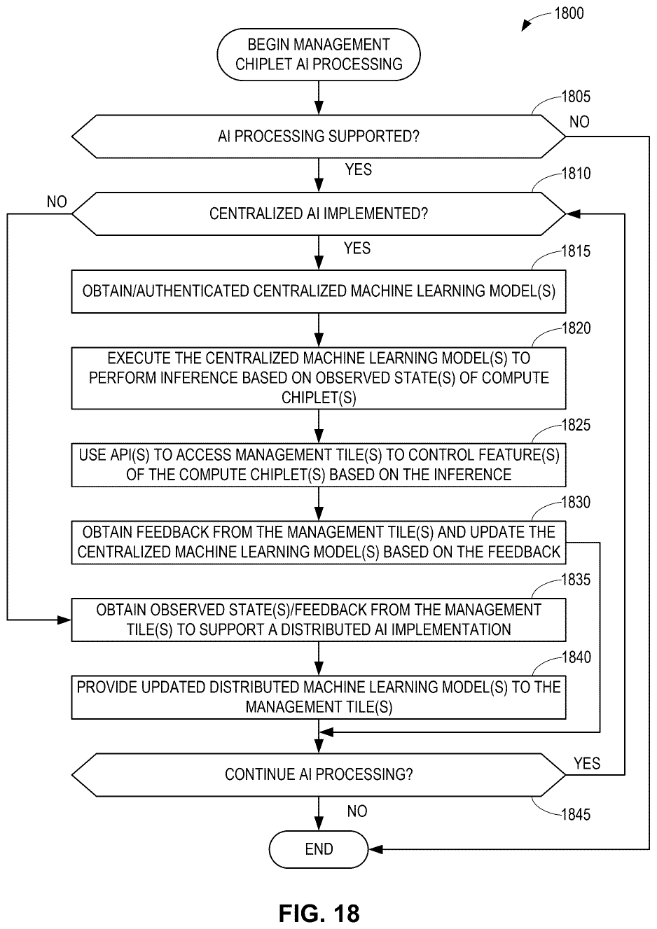

In some examples, the compute device 105A includes means for managing multiple chiplets in the compute device 105A. For example, the means for managing multiple chiplets may be implemented by the management chiplet 115. In some examples, the management chiplet 115 may be instantiated by programmable circuitry such as the example programmable circuitry 1912 of FIG. 19. For instance, the management chiplet 115 may be instantiated by the example microprocessor 2000 of FIG. 20 executing machine executable instructions such as those implemented by at least blocks 1705-1745 of FIG. 17 and/or blocks 1805-1845 of FIG. 18. In some examples, the management chiplet 115 may be instantiated by hardware logic circuitry, which may be implemented by an ASIC, XPU, or the FPGA circuitry 2100 of FIG. 21 configured and/or structured to perform operations corresponding to the machine-readable instructions. Additionally or alternatively, the management chiplet 115 may be instantiated by any other combination of hardware, software, and/or firmware. For example, the management chiplet 115 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the compute device 105A is illustrated in FIGS. 1-8, one or more of the elements, processes, and/or devices illustrated in FIGS. 1-8 may be combined, divided, re-arranged, omitted, eliminated, and/or implemented in any other way. Further, the example compute chiplets 110A-C, the example management chiplet 115, the example management tiles 120A-B, the example compute tiles 205A-C, the processor circuitry 210A-C, the example memories 215A-C, the example memory tile 220 the example memory controller tile 225, the example communication tile 230, the example processor circuitry 245, the example memory 250, the example internal communication chiplet 305, the example external communication chiplet 315, the example UCIe™ interface circuit 310A-C and 320, the example Ethernet transceiver 325, the example processor circuitry 345, the example memory 350, the example attestation circuitry 505, the example configuration circuitry 510, the example rules control circuitry 515, the example attestation circuitry 525, the example discovery circuitry 530, the example access control circuitry 535, the access rules configuration circuitry 540 and/or, more generally, the example compute device 105A of FIGS. 1-8, may be implemented by hardware alone or by hardware in combination with software and/or firmware. Thus, for example, any of the example compute chiplets 110A-C, the example management chiplet 115, the example management tiles 120A-B, the example compute tiles 205A-C, the processor circuitry 210A-C, the example memories 215A-C, the example memory tile 220 the example memory controller tile 225, the example communication tile 230, the example processor circuitry 245, the example memory 250, the example internal communication chiplet 305, the example external communication chiplet 315, the example UCIe™ interface circuit 310A-C and 320, the example Ethernet transceiver 325, the example processor circuitry 345, the example memory 350, the example attestation circuitry 505, the example configuration circuitry 510, the example rules control circuitry 515, the example attestation circuitry 525, the example discovery circuitry 530, the example access control circuitry 535, the access rules configuration circuitry 540, and/or, more generally, the example compute device 105A, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example compute device 105A may include one or more elements, processes, and/or devices in addition to, or instead of, those illustrated in FIGS. 1-8, and/or may include more than one of any or all of the illustrated elements, processes and devices.

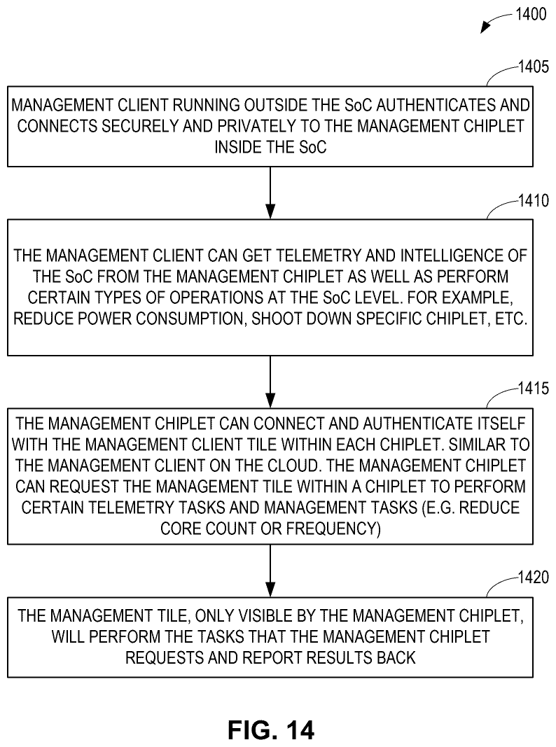

Flowchart(s) representative of example machine-readable instructions, which may be executed by programmable circuitry to implement and/or instantiate the management chiplet 115 and/or the management tiles 120A-B of FIGS. 1-8 and/or representative of example operations which may be performed by programmable circuitry to implement and/or instantiate the management chiplet 115 and/or the management tiles 120A-B of FIGS. 1-8, are shown in FIGS. 14-18. The machine-readable instructions may be one or more executable programs or portion(s) of one or more executable programs for execution by programmable circuitry such as the programmable circuitry 1912 shown in the example processor platform 1900 discussed below in connection with FIG. 19 and/or may be one or more function(s) or portion(s) of functions to be performed by the example programmable circuitry (e.g., an FPGA) discussed below in connection with FIGS. 20 and/or 21. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 14-18, many other methods of implementing the example management chiplet 115 and/or the management tiles 120A-B may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 14-18 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 14 is a flowchart representative of example machine-readable instructions and/or example operations 1400 that may be executed, instantiated, and/or performed by programmable circuitry to implement a multi-tier management architecture in the compute device 105A of FIGS. 1-8. The example machine-readable instructions and/or the example operations 1400 of FIG. 14 begin at block 1405 at which the management client 125 executing outside the compute device 105A authenticates and connects securely and privately to the management chiplet 115 in the compute device 105A.

At block 1410, the management chiplet 115 provides the management client 125 telemetry and intelligence associated with the compute device 105A. At block 1410, the management chiplet 115 also identifies the control operations that the management chiplet 115 can perform in the context of the compute device 105A. For example, such control operations can include reducing power consumption, disabling a particular chiplet, etc.

At block 1415, the management chiplet 115 connects and authenticates itself with the different management tiles included in the different chiplets of the compute device 105A, such as the management tile 120A include in the compute chiplet 110A. At block 1415, the management chiplet 115 also obtains capability information from the different management tiles identifying the sets of APIs implemented by the management tiles to manage their respective chiplets. At block 1415, the management chiplet 115 uses those APIs to request a particular management tile, such as the management tile 120A, to perform one or more telemetry (e.g., observation) and/or management (e.g., control) tasks in its chiplet, such as the compute chiplet 110A. Examples of such tasks include adjusting core count, adjusting operating frequency, etc.

At block 1420, the target management tile, such as the management tile 120A, performs the task(s) requested by the management chiplet 115 and reports the results of the tasks back to the management chiplet 115. The machine-readable instructions and/or the example operations 1400 then end and/or processing proceeds to another entity.

FIG. 15 is a flowchart representative of example machine-readable instructions and/or example operations 1500 that may be executed, instantiated, and/or performed by programmable circuitry to implement the management tile 120A of FIGS. 1-8. The example machine-readable instructions and/or the example operations 1500 of FIG. 15 begin at block 1505 at which the management tile 120A authenticates the management software 260 to be executed by the management tile 120A to provide a set of available API(s) to control/observe the compute chiplet 110A. At block 1510, the management tile 120A determines whether authentication of the management software 260 is successful. If authentication of the management software 260 is successful (corresponding to the “Yes” output of block 1510), control proceeds to block 1515.

At block 1515, the management tile 120A obtains a discovery request from the management chiplet 115. At block 1520, the management tile 120A authenticates the management chiplet 115 associated with the discover request. At block 1525, the management tile 120A determines whether authentication of the management chiplet 115 is successful. If authentication of the management chiplet 115 is successful (corresponding to the “Yes” output of block 1525), control proceeds to block 1530.

At block 1530, the management tile 120A selects one or more APIs from the set of available APIs based on the authentication of the management chiplet 115 (e.g., based on a certificate provided by or associated with the management chiplet 115). At block 1535, the management tile 120A provides the selected set of one or more APIs to the management chiplet 115. At block 1535, the management tile 120A also restricts the management chiplet 115 from access to other unselected API(s) in the set of available APIs. At block 1540, the management tile 120A controls and/or observes the compute chiplet 110A based on one or more API commands from the management chiplet 115.

At block 1545, the management tile 120A determines whether processing is to continue. If processing is to continue (corresponding to the “Yes” output of block 1545), then control returns to block 1540. Otherwise, the machine-readable instructions and/or the example operations 1500 then end and/or processing proceeds to another entity.

Returning to block 1525, if authentication of the management chiplet 115 is unsuccessful (corresponding to the “No” output of block 1525), control returns to block 1515 at which the management tile 120A waits for another discovery request.

Returning to block 1510, if authentication of the management software 260 is unsuccessful (corresponding to the “No” output of block 1510), the machine-readable instructions and/or the example operations 1500 then end and/or processing proceeds to another entity.

FIG. 16 is a flowchart representative of example machine-readable instructions and/or example operations 1600 that may be executed, instantiated, and/or performed by programmable circuitry to implement AI processing in the management tile 120A of FIGS. 1-8. The example machine-readable instructions and/or the example operations 1600 of FIG. 16 begin at block 1605 at which the management tile 120A determines whether AI processing is supported. If AI processing is supported (corresponding to the “Yes” output of block 1605), then at block 1610 the management tile 120A determines whether distributed AI processing is implemented. If distributed AI processing is implemented (corresponding to the “Yes” output of block 1610), control proceeds to block 1615.

At block 1615 the management tile 120A obtains and authenticates one or more machine learning models to be executed by the management tile 120A. At block 1620, the management tile 120A executes the machine learning model(s) to perform inference based on observed state(s) of the compute chiplet 110A. At block 1625, the management tile 120A controls one or more features (e.g., tiles, clocks, supply voltages, etc.) of the compute chiplet 110A based on the inference from the machine learning model(s). At block 1630, the management tile 120A provides feedback associated with the execution of the machine learning model(s) to the management chiplet 115. At block 1635, the management tile 120A obtains update(s) to the machine learning model(s) from the management chiplet 115.

Control then proceeds to block 1645 at which the management tile 120A determines whether AI processing is to continue. If AI processing is to continue (corresponding to the “Yes” output of block 1645), control returns to block 1610. Otherwise, the machine-readable instructions and/or the example operations 1600 then end and/or processing proceeds to another entity.

Returning to block 1610, if distributed AI processing is not implemented (corresponding to the “No” output of block 1610), then centralized AI processing is implemented and control proceeds to block 1640. At block 1640, the management tile 120A provides observed state(s) and/or feedback from the compute chiplet 110A to the management chiplet 115 to support a centralized AI implementation. Control then proceeds to block 1645, which is described above.

Returning to block 1605, if AI processing is not supported (corresponding to the “No” output of block 1605), the machine-readable instructions and/or the example operations 1600 then end and/or processing proceeds to another entity.

FIG. 17 is a flowchart representative of example machine-readable instructions and/or example operations 1700 that may be executed, instantiated, and/or performed by programmable circuitry to implement the management chiplet 115 of FIGS. 1-8. The example machine-readable instructions and/or the example operations 1700 of FIG. 17 begin at block 1705 at which the management chiplet 115 authenticates the management software 360 to be executed by the management chiplet 115 to access management tile(s) and management client(s), such as the management tile 120A and the management client 125. At block 1710, the management chiplet 115 determines whether authentication of the management software 360 is successful. If authentication of the management software 360 is successful (corresponding to the “Yes” output of block 1710), control proceeds to block 1715.

At block 1715, the management chiplet 115 implements a discovery protocol to discover the management tile 120A included in the compute chiplet 110A. At block 1720, the management chiplet 115 determines whether authentication of the management tile 120A is successful. If authentication of the management tile 120A is successful (corresponding to the “Yes” output of block 1720), control proceeds to block 1725.

At block 1725, the management chiplet 115 obtains capability information identifying one or more APIs implemented by the management tile 120A to control and/or observe the compute chiplet 110A. At block 1730, the management chiplet 115 provides access control information to an authenticated client, such as the management client 125. At block 1730, the access control information identifies one or more APIs to permit the management client 125 to control and/or observe the management chiplet 115 itself and/or the management tile 120A included in the compute chiplet 110A. At block 1735, the management chiplet 115 obtains, from the management client 125, command(s) based on the API(s) in the access control information. At block 1740, the management chiplet 115 uses the command(s) from the management client 125 to control and/or observe the compute chiplet 110A based on the API command(s) in the capability information provided by the management tile 120A.

At block 1745, the management chiplet 115 determines whether processing is to continue. If processing is to continue (corresponding to the “Yes” output of block 1745), then control returns to block 1735. Otherwise, the machine-readable instructions and/or the example operations 1700 then end and/or processing proceeds to another entity.

Returning to block 1720, if authentication of the management tile 120A is unsuccessful (corresponding to the “No” output of block 1720), control returns to block 1715 at which the management chiplet 115 implements the discovery protocol to discover another management tile included in another chiplet.

Returning to block 1710, if authentication of the management software 360 is unsuccessful (corresponding to the “No” output of block 1710), the machine-readable instructions and/or the example operations 1700 then end and/or processing proceeds to another entity.

FIG. 18 is a flowchart representative of example machine-readable instructions and/or example operations 1800 that may be executed, instantiated, and/or performed by programmable circuitry to implement AI processing in the management chiplet 115 of FIGS. 1-8. The example machine-readable instructions and/or the example operations 1800 of FIG. 18 begin at block 1805 at which the management chiplet 115 determines whether AI processing is supported. If AI processing is supported (corresponding to the “Yes” output of block 1805), then at block 1810 the management chiplet 115 determines whether centralized AI processing is implemented. If centralized AI processing is implemented (corresponding to the “Yes” output of block 1810), control proceeds to block 1815.

At block 1815 the management chiplet 115 obtains and authenticates one or more machine learning models to be executed by the management chiplet 115. At block 1820, the management chiplet 115 executes the machine learning model(s) to perform inference based on observed state(s) of the compute chiplets, such as the compute chiplet 110A, in the compute device 105A. At block 1825, the management chiplet 115 uses one or more APIs to access management tiles, such as the management tile 120A, to control one or more features (e.g., tiles, clocks, supply voltages, etc.) of the compute chiplets, such as the compute chiplet 110A, based on the inference from the machine learning model(s). At block 1830, the management chiplet 115 obtains feedback from the management tile(s), such as the management tile 120A, and updates to the centralized machine learning model(s) based on the feedback.

Control then proceeds to block 1845 at which the management chiplet 115 determines whether AI processing is to continue. If AI processing is to continue (corresponding to the “Yes” output of block 1845), control returns to block 1810. Otherwise, the machine-readable instructions and/or the example operations 1800 then end and/or processing proceeds to another entity.

Returning to block 1810, if centralized AI processing is not implemented (corresponding to the “No” output of block 1810), then distributed AI processing is implemented and control proceeds to block 1835. At block 1835, the management chiplet 115 obtains observed state(s) and/or feedback from the management tiles, such as the management tile 120A, to support a distributed AI implementation. At block 1840, the management chiplet 115 provides updated distributed machine learning model(s) to the management tile(s), such as the management tile 120A. Control then proceeds to block 1845, which is described above.

Returning to block 1805, if AI processing is not supported (corresponding to the “No” output of block 1805), the machine-readable instructions and/or the example operations 1800 then end and/or processing proceeds to another entity.

FIG. 19 is a block diagram of an example programmable circuitry platform 1900 structured to execute and/or instantiate the example machine-readable instructions and/or the example operations of FIGS. 14-18 to implement the management chiplet 115 and/or the management tiles 120A-B of FIGS. 1-8. The programmable circuitry platform 1900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1900 of the illustrated example includes programmable circuitry 1912. The programmable circuitry 1912 of the illustrated example is hardware. For example, the programmable circuitry 1912 can be implemented by one or more integrated circuits, logic circuits, FPGAs, microprocessors, CPUs, GPUs, DSPs, and/or microcontrollers from any desired family or manufacturer. The programmable circuitry 1912 may be implemented by one or more semiconductor based (e.g., silicon based) devices. In this example, the programmable circuitry 1912 implements the management chiplet 115 and/or the management tiles 120A-B.

The programmable circuitry 1912 of the illustrated example includes a local memory 1913 (e.g., a cache, registers, etc.). The programmable circuitry 1912 of the illustrated example is in communication with main memory 1914, 1916, which includes a volatile memory 1914 and a non-volatile memory 1916, by a bus 1918. The volatile memory 1914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1916 may be implemented by flash memory and/or any other desired type of memory device. Access to the main memory 1914, 1916 of the illustrated example is controlled by a memory controller 1917. In some examples, the memory controller 1917 may be implemented by one or more integrated circuits, logic circuits, microcontrollers from any desired family or manufacturer, or any other type of circuitry to manage the flow of data going to and from the main memory 1914, 1916.

The programmable circuitry platform 1900 of the illustrated example also includes interface circuitry 1920. The interface circuitry 1920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1922 are connected to the interface circuitry 1920. The input device(s) 1922 permit(s) a user (e.g., a human user, a machine user, etc.) to enter data and/or commands into the programmable circuitry 1912. The input device(s) 1922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1924 are also connected to the interface circuitry 1920 of the illustrated example. The output device(s) 1924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1920 of the illustrated example, thus, typically includes a graphics driver card, a graphics driver chip, and/or graphics processor circuitry such as a GPU.

The interface circuitry 1920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1900 of the illustrated example also includes one or more mass storage discs or devices 1928 to store firmware, software, and/or data. Examples of such mass storage discs or devices 1928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1932, which may be implemented by the machine-readable instructions of FIGS. 14-18, may be stored in the mass storage device 1928, in the volatile memory 1914, in the non-volatile memory 1916, and/or on at least one non-transitory computer-readable storage medium such as a CD or DVD which may be removable.

FIG. 20 is a block diagram of an example implementation of the programmable circuitry 1912 of FIG. 19. In this example, the programmable circuitry 1912 of FIG. 19 is implemented by a microprocessor 2000. For example, the microprocessor 2000 may be a general-purpose microprocessor (e.g., general-purpose microprocessor circuitry).

The microprocessor 2000 executes some or all of the machine-readable instructions of the flowcharts of FIGS. 14-18 to effectively instantiate the circuitry of FIGS. 1-8 as logic circuits to perform operations corresponding to those machine-readable instructions. In some such examples, the circuitry of FIGS. 1-8 is instantiated by the hardware circuits of the microprocessor 2000 in combination with the machine-readable instructions. For example, the microprocessor 2000 may be implemented by multi-core hardware circuitry such as a CPU, a DSP, a GPU, an XPU, etc. Although it may include any number of example cores 2002 (e.g., 1 core), the microprocessor 2000 of this example is a multi-core semiconductor device including N cores. The cores 2002 of the microprocessor 2000 may operate independently or may cooperate to execute machine-readable instructions. For example, machine code corresponding to a firmware program, an embedded software program, or a software program may be executed by one of the cores 2002 or may be executed by multiple ones of the cores 2002 at the same or different times. In some examples, the machine code corresponding to the firmware program, the embedded software program, or the software program is split into threads and executed in parallel by two or more of the cores 2002. The software program may correspond to a portion or all of the machine-readable instructions and/or operations represented by the flowcharts of FIGS. 14-18.

The cores 2002 may communicate by a first example bus 2004. In some examples, the first bus 2004 may be implemented by a communication bus to effectuate communication associated with one(s) of the cores 2002. For example, the first bus 2004 may be implemented by at least one of an Inter-Integrated Circuit (I2C) bus, a Serial Peripheral Interface (SPI) bus, a PCI bus, or a PCIe bus. Additionally or alternatively, the first bus 2004 may be implemented by any other type of computing or electrical bus. The cores 2002 may obtain data, instructions, and/or signals from one or more external devices by example interface circuitry 2006. The cores 2002 may output data, instructions, and/or signals to the one or more external devices by the interface circuitry 2006. Although the cores 2002 of this example include example local memory 2020 (e.g., Level 1 (L1) cache that may be split into an L1 data cache and an L1 instruction cache), the microprocessor 2000 also includes example shared memory 2010 that may be shared by the cores (e.g., Level 2 (L2 cache)) for high-speed access to data and/or instructions. Data and/or instructions may be transferred (e.g., shared) by writing to and/or reading from the shared memory 2010. The local memory 2020 of each of the cores 2002 and the shared memory 2010 may be part of a hierarchy of storage devices including multiple levels of cache memory and the main memory (e.g., the main memory 1914, 1916 of FIG. 19). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 2002 may be referred to as a CPU, DSP, GPU, etc., or any other type of hardware circuitry. Each core 2002 includes control unit circuitry 2014, arithmetic and logic (AL) circuitry (sometimes referred to as an ALU) 2016, a plurality of registers 2018, the local memory 2020, and a second example bus 2022. Other structures may be present. For example, each core 2002 may include vector unit circuitry, single instruction multiple data (SIMD) unit circuitry, load/store unit (LSU) circuitry, branch/jump unit circuitry, floating-point unit (FPU) circuitry, etc. The control unit circuitry 2014 includes semiconductor-based circuits structured to control (e.g., coordinate) data movement within the corresponding core 2002. The AL circuitry 2016 includes semiconductor-based circuits structured to perform one or more mathematic and/or logic operations on the data within the corresponding core 2002. The AL circuitry 2016 of some examples performs integer based operations. In other examples, the AL circuitry 2016 also performs floating-point operations. In yet other examples, the AL circuitry 2016 may include first AL circuitry that performs integer-based operations and second AL circuitry that performs floating-point operations. In some examples, the AL circuitry 2016 may be referred to as an Arithmetic Logic Unit (ALU).

The registers 2018 are semiconductor-based structures to store data and/or instructions such as results of one or more of the operations performed by the AL circuitry 2016 of the corresponding core 2002. For example, the registers 2018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 2018 may be arranged in a bank as shown in FIG. 20. Alternatively, the registers 2018 may be organized in any other arrangement, format, or structure, such as by being distributed throughout the core 2002 to shorten access time. The second bus 2022 may be implemented by at least one of an I2C bus, a SPI bus, a PCI bus, or a PCIe bus.

Each core 2002 and/or, more generally, the microprocessor 2000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 2000 is a semiconductor device fabricated to include many transistors interconnected to implement the structures described above in one or more integrated circuits (ICs) contained in one or more packages.

The microprocessor 2000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 2000, in the same chip package as the microprocessor 2000 and/or in one or more separate packages from the microprocessor 2000.

FIG. 21 is a block diagram of another example implementation of the programmable circuitry 1912 of FIG. 19. In this example, the programmable circuitry 1912 is implemented by FPGA circuitry 2100. For example, the FPGA circuitry 2100 may be implemented by an FPGA. The FPGA circuitry 2100 can be used, for example, to perform operations that could otherwise be performed by the example microprocessor 2000 of FIG. 20 executing corresponding machine-readable instructions. However, once configured, the FPGA circuitry 2100 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 2000 of FIG. 20 described above (which is a general purpose device that may be programmed to execute some or all of the machine-readable instructions represented by the flowchart(s) of FIGS. 14-18 but whose interconnections and logic circuitry are fixed once fabricated), the FPGA circuitry 2100 of the example of FIG. 21 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 14-18. In particular, the FPGA circuitry 2100 may be thought of as an array of logic gates, interconnections, and switches. The switches can be programmed to change how the logic gates are interconnected by the interconnections, effectively forming one or more dedicated logic circuits (unless and until the FPGA circuitry 2100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 14-18. As such, the FPGA circuitry 2100 may be configured and/or structured to effectively instantiate some or all of the operations/functions corresponding to the machine-readable instructions of the flowchart(s) of FIGS. 14-18 as dedicated logic circuits to perform the operations/functions corresponding to those software instructions in a dedicated manner analogous to an ASIC. Therefore, the FPGA circuitry 2100 may perform the operations/functions corresponding to the some or all of the machine-readable instructions of FIGS. 14-18 faster than the general-purpose microprocessor can execute the same.

In the example of FIG. 21, the FPGA circuitry 2100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 2100 of FIG. 21 may access and/or load the binary file to cause the FPGA circuitry 2100 of FIG. 21 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2100 of FIG. 21 to cause configuration and/or structuring of the FPGA circuitry 2100 of FIG. 21, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 2100 of FIG. 21 may access and/or load the binary file to cause the FPGA circuitry 2100 of FIG. 21 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2100 of FIG. 21 to cause configuration and/or structuring of the FPGA circuitry 2100 of FIG. 21, or portion(s) thereof.

The FPGA circuitry 2100 of FIG. 21, includes example input/output (I/O) circuitry 2102 to obtain and/or output data to/from example configuration circuitry 2104 and/or external hardware 2106. For example, the configuration circuitry 2104 may be implemented by interface circuitry that may obtain a binary file, which may be implemented by a bit stream, data, and/or machine-readable instructions, to configure the FPGA circuitry 2100, or portion(s) thereof. In some such examples, the configuration circuitry 2104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 2106 may be implemented by external hardware circuitry. For example, the external hardware 2106 may be implemented by the microprocessor 2000 of FIG. 20.

The FPGA circuitry 2100 also includes an array of example logic gate circuitry 2108, a plurality of example configurable interconnections 2110, and example storage circuitry 2112. The logic gate circuitry 2108 and the configurable interconnections 2110 are configurable to instantiate one or more operations/functions that may correspond to at least some of the machine-readable instructions of FIGS. 14-18 and/or other desired operations. The logic gate circuitry 2108 shown in FIG. 21 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2108 to enable configuration of the electrical structures and/or the logic gates to form circuits to perform desired operations/functions. The logic gate circuitry 2108 may include other electrical structures such as look-up tables (LUTs), registers (e.g., flip-flops or latches), multiplexers, etc.

The configurable interconnections 2110 of the illustrated example are conductive pathways, traces, vias, etc., that may include electrically controllable switches (e.g., transistors) whose state can be changed by programming (e.g., using an HDL instruction language) to activate or deactivate one or more connections between one or more of the logic gate circuitry 2108 to program desired logic circuits.

The storage circuitry 2112 of the illustrated example is structured to store result(s) of the one or more of the operations performed by corresponding logic gates. The storage circuitry 2112 may be implemented by registers or similar structures. In the illustrated example, the storage circuitry 2112 is distributed amongst the logic gate circuitry 2108 to facilitate access and increase execution speed.

The example FPGA circuitry 2100 of FIG. 21 also includes example dedicated operations circuitry 2114. In this example, the dedicated operations circuitry 2114 includes special purpose circuitry 2116 that may be invoked to implement commonly used functions to avoid the need to program those functions in the field. Examples of such special purpose circuitry 2116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2100 may also include example general purpose programmable circuitry 2118 such as an example CPU 2120 and/or an example DSP 2122. Other general purpose programmable circuitry 2118 may additionally or alternatively be present such as a GPU, an XPU, etc., that can be programmed to perform other operations.

Although FIGS. 20 and 21 illustrate two example implementations of the programmable circuitry 1912 of FIG. 19, many other approaches are contemplated. For example, FPGA circuitry may include an on-board CPU, such as one or more of the example CPU 2120 of FIG. 20. Therefore, the programmable circuitry 1912 of FIG. 19 may additionally be implemented by combining at least the example microprocessor 2000 of FIG. 20 and the example FPGA circuitry 2100 of FIG. 21. In some such hybrid examples, one or more cores 2002 of FIG. 20 may execute a first portion of the machine-readable instructions represented by the flowchart(s) of FIGS. 14-18 to perform first operation(s)/function(s), the FPGA circuitry 2100 of FIG. 21 may be configured and/or structured to perform second operation(s)/function(s) corresponding to a second portion of the machine-readable instructions represented by the flowcharts of FIG. 14-18, and/or an ASIC may be configured and/or structured to perform third operation(s)/function(s) corresponding to a third portion of the machine-readable instructions represented by the flowcharts of FIGS. 14-18.

It should be understood that some or all of the circuitry of FIGS. 1-8 may, thus, be instantiated at the same or different times. For example, same and/or different portion(s) of the microprocessor 2000 of FIG. 20 may be programmed to execute portion(s) of machine-readable instructions at the same and/or different times. In some examples, same and/or different portion(s) of the FPGA circuitry 2100 of FIG. 21 may be configured and/or structured to perform operations/functions corresponding to portion(s) of machine-readable instructions at the same and/or different times.

In some examples, some or all of the circuitry of FIGS. 1-8 may be instantiated, for example, in one or more threads executing concurrently and/or in series. For example, the microprocessor 2000 of FIG. 20 may execute machine-readable instructions in one or more threads executing concurrently and/or in series. In some examples, the FPGA circuitry 2100 of FIG. 21 may be configured and/or structured to carry out operations/functions concurrently and/or in series. Moreover, in some examples, some or all of the circuitry of FIGS. 1-8 may be implemented within one or more virtual machines and/or containers executing on the microprocessor 2000 of FIG. 20.

In some examples, the programmable circuitry 1912 of FIG. 19 may be in one or more packages. For example, the microprocessor 2000 of FIG. 20 and/or the FPGA circuitry 2100 of FIG. 21 may be in one or more packages. In some examples, an XPU may be implemented by the programmable circuitry 1912 of FIG. 19, which may be in one or more packages. For example, the XPU may include a CPU (e.g., the microprocessor 2000 of FIG. 20, the CPU 2120 of FIG. 21, etc.) in one package, a DSP (e.g., the DSP 2122 of FIG. 21) in another package, a GPU in yet another package, and an FPGA (e.g., the FPGA circuitry 2100 of FIG. 21) in still yet another package.

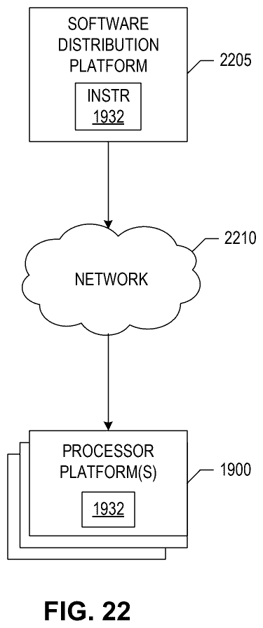

A block diagram illustrating an example software distribution platform 2205 to distribute software such as the example machine-readable instructions 1932 of FIG. 19 to other hardware devices (e.g., hardware devices owned and/or operated by third parties from the owner and/or operator of the software distribution platform) is illustrated in FIG. 22. The example software distribution platform 2205 may be implemented by any computer server, data facility, cloud service, etc., capable of storing and transmitting software to other computing devices. The third parties may be customers of the entity owning and/or operating the software distribution platform 2205. For example, the entity that owns and/or operates the software distribution platform 2205 may be a developer, a seller, and/or a licensor of software such as the example machine-readable instructions 1932 of FIG. 19. The third parties may be consumers, users, retailers, OEMs, etc., who purchase and/or license the software for use and/or re-sale and/or sub-licensing. In the illustrated example, the software distribution platform 2205 includes one or more servers and one or more storage devices. The storage devices store the machine-readable instructions 1932, which may correspond to the example machine-readable instructions of FIGS. 14-18, as described above. The one or more servers of the example software distribution platform 2205 are in communication with an example network 2210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1932 from the software distribution platform 2205. For example, the software, which may correspond to the example machine-readable instructions of FIG. 14-18, may be downloaded to the example programmable circuitry platform 1900, which is to execute the machine-readable instructions 1932 to implement the management chiplet 115 and/or the management tiles 120A-B. In some examples, one or more servers of the software distribution platform 2205 periodically offer, transmit, and/or force updates to the software (e.g., the example machine-readable instructions 1932 of FIG. 19) to ensure improvements, patches, updates, etc., are distributed and applied to the software at the end user devices. Although referred to as software above, the distributed “software” could alternatively be firmware.

The instructions 1932 may be transmitted or received over the network 2210 using a transmission medium via the interface circuitry 1920 of FIG. 19 and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and/or wireless data networks (e.g., Institute of Electrical and Electronics Engineers (IEEE) 802.11 family of standards known as Wi-Fi®), IEEE 802.15.4 family of standards, peer-to-peer (P2P) networks, among others.

A computing program may be written in any form of programming language, including compiled or interpreted languages, and it may be deployed in any form, including as a stand-alone program and/or as a module, component, subroutine, and/or other unit suitable for use in a computing environment. Also, programs, codes, and/or code segments for accomplishing the techniques described herein are construed as within the scope of the present disclosure by programmers of ordinary skill in the art.

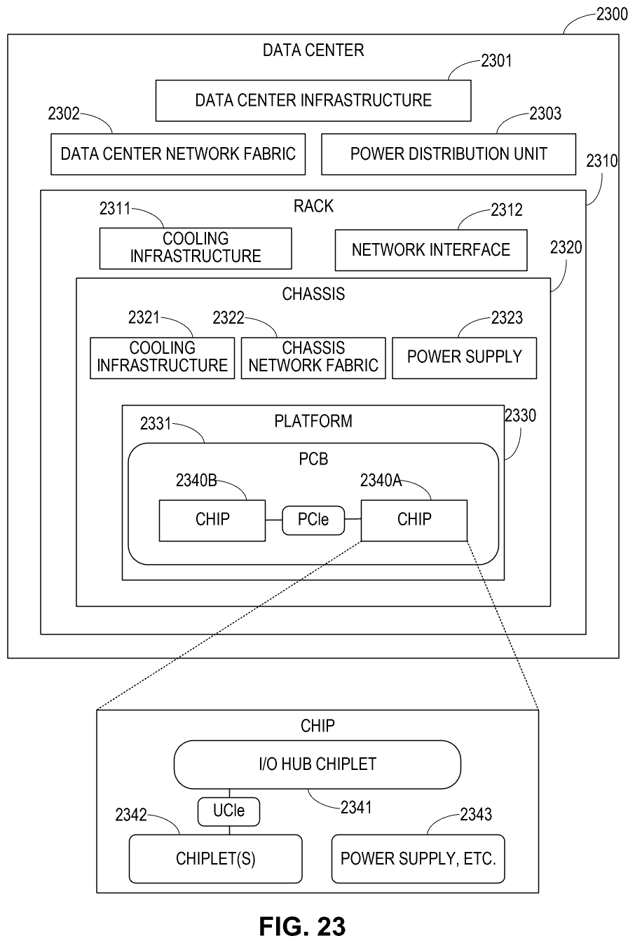

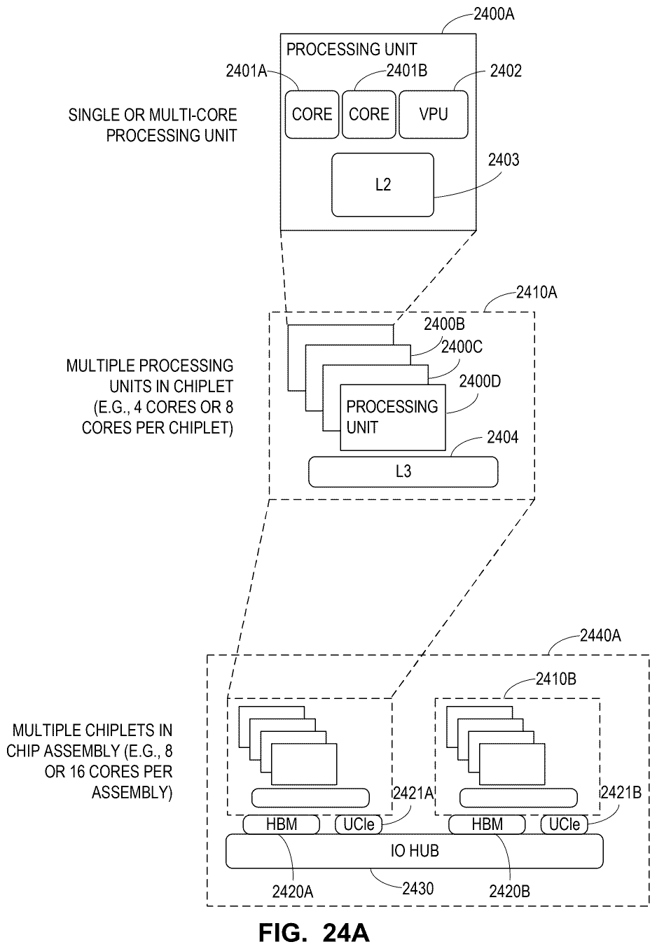

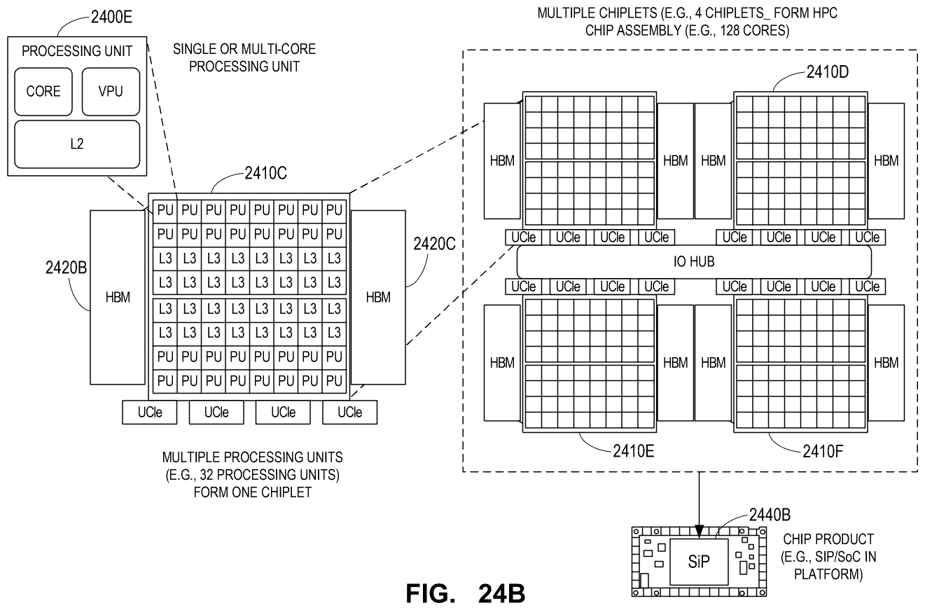

FIGS. 23, 24A, and 24B include further example computing architectures in which any of the techniques and configurations above may be implemented.

FIG. 23 illustrates an example hardware arrangement of an example data center 2300 used to provide multiple examples or instances of a computing system (e.g., the programmable circuitry platform 1900, described above), with each example of the computing system identified as a respective platform (e.g., the platform 2330, described below). The data center 2300 includes example data center infrastructure 2301, an example data center network fabric 2302, and an example power distribution unit 2303 to support multiple racks of compute platforms, with a single instance of an example rack 2310 depicted. The data center infrastructure 2301 may provide physical components that host the compute platform hardware, storage components, and/or networking equipment. The data center network fabric 2302 may include switches and/or networking components to support data flows among various compute platforms and storage devices throughout the data center. The power distribution unit 2303 may include components to distribute and/or control power among the various compute platforms, networking, and storage devices.

The rack 2310 of FIG. 23 includes, but is not limited to, example cooling infrastructure 2311, an example network interface 2312, and/or other related physical components to support discrete instances of multiple chassis. The rack 2310 provides power, connectivity, and/or cooling to each of the multiple chassis in a single rack, with a single instance of a chassis 2320 in the example of FIG. 23. The chassis 2320 includes, but is not limited to, example cooling infrastructure 2321, an example chassis network fabric 2322, and an example power supply 2323, which provides cooling, network connectivity, and/or power to multiple platforms within the chassis. Although a single instance of an example platform 2330 is illustrated in FIG. 23, in some examples, a common data center rack configuration may include dozens of chassis, with each chassis to support a number of platforms depending on the physical size of the platform hardware and/or supporting equipment.

The platform 2330 of FIG. 23 may be referred to as a server or node, depending on the use case for the platform 2330 and the data center 2300. The platform 2330 includes but is not limited to examples of a discrete computing system hosted on a single board. In FIG. 23, the platform 2330 is illustrated as hosting a first example chip assembly 2340A and a second example chip assembly 2340B on a first board provided by a printed circuitry board (PCB) or other platform board, shown as an example PCB 2331. In some examples, the platform 2330 may include only one chip package, whereas the PCB 2331 includes interconnection of multiple chip assemblies via an interface (e.g., a peripheral component interconnect express (PCIe) interface). Additional chip packages and components may also be hosted on the PCB 2331.

Some examples of the chip assembly 2340A, 2340B of FIG. 23 may be termed as a System-on-Chip (SoC) package, as modular chiplets that perform different functions are integrated into a single package—even though this chip package is composed of multiple dies unlike a traditional SoC design that uses a single die. Other examples of the chip assembly 2340A, 2340B may include a System-on-Package (SoP), System-in-a-Package (SiP), or other single chip packages. Various combinations of 2 dimension (D), 2.5D, and/or 3D packaging technologies may be used to manufacture and/or assemble the chip package and its underlying structure. Additionally, different manufacturing processes may be used to provide chiplets and components from different process nodes (e.g., semiconductor fabrication systems).

The first chip assembly 2340A and the second chip assembly 2340B of FIG. 23 are packages that include multiple chiplets and/or dies for respective functions, such as separate chiplets for processing (e.g., central processing unit (CPU) or graphical processing unit (GPU) chiplets), memory (e.g., cache or high-bandwidth memory chiplets), input/output (I/O) (e.g., I/O chiplets), acceleration (e.g., artificial intelligence (AI)/machine learning (ML) acceleration chiplets), signal processing (e.g., audio or video processing chiplets), etc. The close-up of chip assembly 2340A of FIG. 23 includes a I/O Hub chiplet 2341, chiplets 2342, and a power supply 2343. These components may be hosted on an interposer that is designed to connect multiple dies and/or components within a single semiconductor package (e.g., chip package). In some examples, the chiplets 2342 may be manufactured and/or sourced separately and later assembled into the chip package to create the chip assembly 2340A. Various connections may be provided among the chiplets 2342, such as with the use of Universal Chiplet Interconnect Express (UCIe) interfaces and communications, and/or between chiplets and on-chip memory (e.g., high-bandwidth memory (HBM)) using HBM3 (JEDEC), Universal Memory Interface (UMI), or other memory interfaces.

FIG. 24A illustrates an example arrangement of an example chip assembly 2440A (e.g., a multi-processing core example of the first chip assembly 2340A or the second chip assembly 2340B of FIG. 23), with expanded views of the chiplets and processing units included herein. In FIG. 24A the chip assembly 2440A, which may constitute an SoC, SoP, SiP, and/or other type of chip package, includes chiplets such as an example chiplet 2410A, an example chiplet 2410B, etc. and associated on-package memory (e.g., high-speed memory) such as 3D-stacked, High Bandwidth Memory (HBM) instances (shown as an example HBM 2420A, an example HBM 2420B, interfaces (e.g., UCIe interfaces) shown as an example UCIe 2421A, an example UCIe 2421B, and an example I/O hub 2430 (e.g., which may be implemented by a I/O chiplet). Other hardware elements of a chip package are not included for simplicity. Although the examples disclosed herein are described in conjunction with UCLe interfaces, one or more of the interfaces may be device-to-device (Dev2Dev) interfaces (e.g., CXLI, peripheral component interconnect express (PCIE)), die to die (D2D) interfaces (e.g., NVLINK), chiplet to chiplet (Ch2Ch) interfaces (e.g., universal chiplet interconnected express (UCIe)), core to core (C2C) interfaces (e.g., using coherency protocols), etc.

The chiplets 2410A, 2410B of FIG. 24A include multiple processing units and the example processing units 2400A, 2400B, 2400C, 2400D include one or multiple cores, respectively. For example, the chiplet 2410A of FIG. 24A includes four processing units (the processing units 2400A, 2400B, 2400C, 2400D) and an example Level 3(L3 ) cache 2404. The processing units 2400A, 2400B, 2400C, 2400D may include one or multiple processing cores, one or multiple caches, other processing units and/or passive and/or active elements. For example, processing unit 2400A includes two cores (an example core 2401A and an example core 2401B), vector processing unit 2402, and an example level 2 (L2) cache 2403. Accordingly, a single-core processing unit can provide four cores per chiplet and eight total cores in a two-chiplet chip assembly, whereas a dual-core processing unit can provide eight cores per chiplet and sixteen total cores in a two-chiplet chip assembly. However, examples disclosed herein may correspond to other permutations.

FIG. 24B is an example arrangement of an example chip assembly 2440B (e.g., a multi-chiplet high-performance computing (HPC) example of chip assembly 2340A, 2340B), adapted for HPC applications (e.g., parallel processing operations involving thousands, millions, or more of processors and/or cores operating simultaneously). The example chip assembly 2440B illustrates placement as a SiP, SoC, and/or other package onto a platform board (e.g., the PCB 2331 of FIG. 23). The platform board may be in a data center (e.g., the data center 2300 of FIG. 23) or in a standalone deployment setting (e.g., in a standalone computer system, mobile computing device, autonomous device, etc.).

The chip assembly 2440B of FIG. 24B is composed of multiple chiplets, shown with four chiplets, including example chiplets 2410C, 2410D, 2410E, 2410F. The chiplets 2410C, 2410D, 2410E, 2410F include multiple processing units, such as thirty two processing units with a corresponding level 3(L3 ) cache for each processing unit. The processing units may include one or multiple cores, such as an example single-core processing unit 2400E shown as part of the chiplet 2410C. The chip assembly 2440B also includes corresponding memory resources, such as HBM elements corresponding to respective banks of processing units (e.g., HBM 2420B and HBM 2420C corresponding respective sets of processing units of chiplet 2410C), UCIe interfaces, and/or an IO Hub.

The chip assembly and related products or devices described herein may be configured in a variety of computing system examples. Such examples include non-transitory machine-readable media storing machine-readable instructions and one or more processors coupled to the memory, such that executing the machine-readable instructions configure one or more of the processors and/or implementing hardware (e.g., the processing unit 2400, the chiplet 2410, the chip 2340, and/or the platform 2330 of FIGS. 23, 24A, and/or 24B) to perform operations described above for electronic systems or devices (e.g., to implement multi-tier management architectures for compute devices, etc.). It should be further understood that software, including one or more machine readable instructions, that facilitates processing and operations as described above may be distributed, installed, or otherwise provided to networked devices (e.g., servers or cloud computing systems). Additionally or alternatively, in some examples, the software may be obtained and loaded (or, re-loaded/upgraded) from one or more servers and/or cloud computing systems, such as software stored on a server for distribution over the Internet, for example.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement multi-tier management architectures for compute devices. Disclosed example systems, apparatus, articles of manufacture, and methods improve the efficiency of using a computing device by employing management tile(s) and management chiplet(s) that implement a multi-tier management architecture that is inaccessible to the bare metal OS that executes on a compute device. Because the management tile(s) and the management chiplet(s) of such examples are inaccessible to the bare metal OS, disclosed example management architectures are less vulnerable to malware attacks, security breaches, OS failures, etc., than other management architectures. Also, such example management tile(s) and/or management chiplet(s) do not consume resources of the bare metal OS, thereby freeing those resources for other application(s) executing on the compute device. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus (e.g., a multi-tier management architecture, a multi-tier management architecture apparatus, a compute device, an SoC, etc.) comprising a compute chiplet including a compute tile and a management tile, the management tile isolated from access by an operating system to be executed by the compute tile, the management tile to at least one of control a feature of the compute tile or observe a state of the compute tile, and a management chiplet coupled with the compute chiplet, the management chiplet to discover the management tile, and obtain capability information that identifies one or more application programming interfaces (APIs) implemented by the management tile to at least one of control the feature of the compute tile or observe the state of the compute tile.

Example 2 includes the apparatus of example 1, wherein the management tile is associated with a first manufacturer and the compute tile is associated with a second manufacturer different from the first manufacturer.

Example 3 includes the apparatus of example 1 or example 2, wherein the operating system is a first operating system, the compute tile includes first memory and first processor circuitry to execute the first operating system, the first memory is associated with a first address space, the management tile includes second memory and second processor circuitry, and the second memory is associated with a second address space different from the first address space to isolate the management tile from access by the first operating system.

Example 4 includes the apparatus of any one or more of the foregoing examples, wherein the second processor circuitry is to execute a second operating system and management software, the second operating system different from the first operating system, the management software to at least one of control the feature of the compute tile or observe the state of the compute tile, the second operating system and the management software not accessible by the first operating system.

Example 5 includes the apparatus of any one or more of the foregoing examples, wherein the management tile is to authenticate the management software before execution of the management software.

Example 6 includes the apparatus of any one or more of the foregoing examples, wherein the management tile is to at least one of perform power management associated with the compute tile, monitor utilization of one or more cores of the compute tile, monitor temperature of the one or more cores of the compute tile, perform clock frequency regulation associated with the compute tile, perform voltage regulation associated with the compute tile, or access telemetry associated with the compute tile.

Example 7 includes the apparatus of any one or more of the foregoing examples, wherein the one or more APIs includes a first set of one or more APIs, the management chiplet is to communicate with a management client external to the apparatus, the management chiplet is to provide the management client with access to a second set of one or more APIs after authentication of the management client, and the second set of one or more APIs is to at least one of control or observe at least one of the compute chiplet or the management chiplet.

Example 8 includes the apparatus of any one or more of the foregoing examples, wherein the management chiplet is to authenticate the management tile after the management tile is discovered, and obtain the capability information after the management tile is discovered.

Example 9 includes the apparatus of any one or more of the foregoing examples, wherein the management tile is to authenticate the management chiplet, and select the one or more APIs to be an approved subset of available APIs based on the authentication of the management chiplet.

Example 10 includes the apparatus of any one or more of the foregoing examples, wherein the management tile is to select the one or more APIs based on a certificate provided by the management chiplet, and restrict the management chiplet from access to other ones of the set of APIs not included in the approved subset of available APIs.

Example 11 includes the apparatus of any one or more of the foregoing examples, wherein at least one of the management chiplet is to store a first result of the authentication of the management tile, and the management chiplet is to use the first result to skip a second authentication of the management tile after a reboot of the apparatus, or the management tile is to store a second result of the authentication of the management chiplet, and the is management tile to use the second result to skip a second authentication of the management chiplet after a reboot of the apparatus.

Example 12 includes the apparatus of any one or more of the foregoing examples, including a plurality of compute chiplets, wherein the compute chiplet is one of the plurality of compute chiplets, the compute chiplets include respective management tiles, and the management chiplet is to obtain capability information that identifies respective sets of APIs to be used to access corresponding ones of the management tiles to manage respective ones of the compute chiplets, and provide access control information to a management client external to the apparatus, the access control information to identify ones of the compute chiplets and ones of the APIs that are accessible to the management client, the access control information based on authentication of the management client by the management chiplet.

Example 13 includes the apparatus of any one or more of the foregoing examples, wherein the management tile is to observe the state of the compute tile, execute a machine learning algorithm to perform inference based on the observed state, and control the feature of the compute tile based on the inference.

Example 14 includes the apparatus of any one or more of the foregoing examples, wherein the management tile is to provide feedback associated with the execution of the machine learning algorithm to the management chiplet, and obtain an update to the machine learning algorithm from the management chiplet.

Example 15 includes the apparatus of any one or more of the foregoing examples, wherein the management tile is to authenticate the machine learning algorithm before the machine learning algorithm is executed.

Example 16 includes the apparatus of any one or more of the foregoing examples, wherein the management chiplet is to access the management tile via the one or more APIs to observe the state of the compute tile, execute a machine learning algorithm to perform inference based on the observed state, and access the management tile via the one or more APIs to control the feature of the compute tile based on the inference performed by the machine learning algorithm.

Example 17 includes the apparatus of any one or more of the foregoing examples, wherein the management chiplet is to authenticate the machine learning algorithm before the machine learning algorithm is executed.

Example 18 includes an apparatus (e.g., a management chiplet, etc.) comprising interface circuitry to communicate with one or more chiplets, machine-readable instructions, and at least one processor circuit to be programmed based on the machine-readable instructions to discover a management tile included in a first chiplet of the one or more chiplets, authenticate the management tile, and after the management tile is authenticated, obtain information from the management tile that identifies one or more application programming interfaces (APIs) implemented by the management tile to at least one or control or observe the first chiplet.

Example 19 includes the apparatus of any one or more of the foregoing examples, wherein the one or more APIs is a first set of one or more APIs, one or more of the at least one processor circuit is to provide a management system with access to a second set of one or more APIs, the second set of one or more APIs to at least one of control or observe at least one of the apparatus or the first chiplet.

Example 20 includes the apparatus of any one or more of the foregoing examples, wherein one or more of the at least one processor circuit is to authenticate the management system before the second set of one or more APIs is provided to the management system.

Example 21 includes the apparatus of any one or more of the foregoing examples, wherein one or more of the at least one processor circuit is to cause storage of a result of the authentication of the management tile, and use the result to skip a second authentication of the management tile after a reboot.

Example 22 includes the apparatus of any one or more of the foregoing examples, wherein the one or more chiplets is a plurality of chiplets, and one or more of the at least one processor circuit is to discover respective management tiles included in the plurality of chiplets, obtain capability information that identifies respective sets of APIs to be used to access corresponding ones of the management tiles to manage respective ones of the chiplets, and provide access control information to a management system external to the apparatus, the access control information to identify ones of the chiplets and ones of the APIs that are accessible to the management system.

Example 23 includes the apparatus of any one or more of the foregoing examples, wherein one or more of the at least one processor circuit is to access the management tile via the one or more APIs to observe a state of the first chiplet, execute a machine learning algorithm to perform inference based on the observed state, and access the management tile via the one or more APIs to control a feature of the first chiplet based on the inference.

Example 24 includes the apparatus of any one or more of the foregoing examples, wherein one or more of the at least one processor circuit is to authenticate the machine learning algorithm.

Example 25 includes an apparatus (e.g., a management tile, etc.) comprising interface circuitry to communicate with a management chiplet, machine-readable instructions, and at least one processor circuit to be programmed based on the machine-readable instructions to implement a set of application programming interfaces (APIs) to at least one or control or observe a compute chiplet, select one or more APIs from the set of APIs based on authentication of the management chiplet, and provide information that identifies the selected one or more APIs to the management chiplet.

Example 26 includes the apparatus of any one or more of the foregoing examples, wherein the selected one or more APIs form a subset of approved APIs, and one or more of the at least one processor circuit is to restrict the management chiplet from access to other ones of the APIs not included in the subset of approved APIs.

Example 27 includes the apparatus of any one or more of the foregoing examples, wherein one or more of the at least one processor circuit is to select the one or more APIs based on a certificate provided by the management chiplet.

Example 28 includes the apparatus of any one or more of the foregoing examples, wherein one or more of the at least one processor circuit is to cause storage of a result of the authentication of the management chiplet, and use the result to skip a second authentication of the management chiplet after a reboot.

Example 29 includes the apparatus of any one or more of the foregoing examples, wherein one or more of the at least one processor circuit is to observe a state of the compute chiplet, execute a machine learning algorithm to perform inference based on the observed state, and control a feature of the compute chiplet based on the inference.

Example 30 includes the apparatus of any one or more of the foregoing examples, wherein one or more of the at least one processor circuit is to authenticate the machine learning algorithm, provide feedback associated with the execution of the machine learning algorithm to the management chiplet, and obtain an update to the machine learning algorithm from the management chiplet.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
a compute chiplet including a compute tile and a management tile, the management tile isolated from access by an operating system to be executed by the compute tile, the management tile to at least one of control a feature of the compute tile or observe a state of the compute tile; and
a management chiplet coupled with the compute chiplet, the management chiplet to:
discover the management tile; and
obtain capability information that identifies one or more application programming interfaces (APIs) implemented by the management tile to at least one of control the feature of the compute tile or observe the state of the compute tile.

2. The apparatus of claim 1, wherein the management tile is associated with a first manufacturer and the compute tile is associated with a second manufacturer different from the first manufacturer.

3. The apparatus of claim 1, wherein the operating system is a first operating system, the compute tile includes first memory and first processor circuitry to execute the first operating system, the first memory is associated with a first address space, the management tile includes second memory and second processor circuitry, and the second memory is associated with a second address space different from the first address space to isolate the management tile from access by the first operating system.

4. The apparatus of claim 3, wherein the second processor circuitry is to execute a second operating system and management software, the second operating system different from the first operating system, the management software to at least one of control the feature of the compute tile or observe the state of the compute tile, the second operating system and the management software not accessible by the first operating system.

5. The apparatus of claim 4, wherein the management tile is to authenticate the management software before execution of the management software.

6. The apparatus of claim 1, wherein the management tile is to at least one of perform power management associated with the compute tile, monitor utilization of one or more cores of the compute tile, monitor temperature of the one or more cores of the compute tile, perform clock frequency regulation associated with the compute tile, perform voltage regulation associated with the compute tile, or access telemetry associated with the compute tile.

7. The apparatus of claim 1, wherein the one or more APIs includes a first set of one or more APIs, the management chiplet is to communicate with a management client external to the apparatus, the management chiplet is to provide the management client with access to a second set of one or more APIs after authentication of the management client, and the second set of one or more APIs is to at least one of control or observe at least one of the compute chiplet or the management chiplet.

8. The apparatus of claim 1, wherein the management chiplet is to:
authenticate the management tile after the management tile is discovered; and
obtain the capability information after the management tile is discovered.

9. The apparatus of claim 1, wherein the management tile is to:
authenticate the management chiplet; and
select the one or more APIs to be an approved subset of available APIs based on the authentication of the management chiplet.

10. The apparatus of claim 9, wherein the management tile is to:
select the one or more APIs based on a certificate provided by the management chiplet; and
restrict the management chiplet from access to other ones of the APIs not included in the approved subset of available APIs.

11. The apparatus of claim 9, wherein at least one of:
the management chiplet is to store a first result of the authentication of the management tile, and the management chiplet is to use the first result to skip a second authentication of the management tile after a reboot of the apparatus; or
the management tile is to store a second result of the authentication of the management chiplet, and the management tile is to use the second result to skip a second authentication of the management chiplet after a reboot of the apparatus.

12. The apparatus of claim 1, including a plurality of compute chiplets, wherein the compute chiplet is one of the plurality of compute chiplets, the compute chiplets include respective management tiles, and the management chiplet is to:
obtain capability information that identifies respective sets of APIs to be used to access corresponding ones of the management tiles to manage respective ones of the compute chiplets; and
provide access control information to a management client external to the apparatus, the access control information to identify ones of the compute chiplets and ones of the APIs that are accessible to the management client, the access control information based on authentication of the management client by the management chiplet.

13. The apparatus of claim 1, wherein the management tile is to:
observe the state of the compute tile;
execute a machine learning algorithm to perform inference based on the observed state; and
control the feature of the compute tile based on the inference.

14. The apparatus of claim 13, wherein the management tile is to:
provide feedback associated with the execution of the machine learning algorithm to the management chiplet; and
obtain an update to the machine learning algorithm from the management chiplet.

15. The apparatus of claim 13, wherein the management tile is to authenticate the machine learning algorithm before the machine learning algorithm is executed.

16. The apparatus of claim 1, wherein the management chiplet is to:
access the management tile via the one or more APIs to observe the state of the compute tile;
execute a machine learning algorithm to perform inference based on the observed state; and
access the management tile via the one or more APIs to control the feature of the compute tile based on the inference performed by the machine learning algorithm.

17. The apparatus of claim 16, wherein the management chiplet is to authenticate the machine learning algorithm before the machine learning algorithm is executed.

18. An apparatus comprising:
interface circuitry to communicate with one or more chiplets;
machine-readable instructions; and
at least one processor circuit to be programmed based on the machine-readable instructions to:
discover a management tile included in a first chiplet of the one or more chiplets;
authenticate the management tile; and
after the management tile is authenticated, obtain information from the management tile that identifies one or more application programming interfaces (APIs) implemented by the management tile to at least one or control or observe the first chiplet.

19-24. (canceled)

25. An apparatus comprising:
interface circuitry to communicate with a management chiplet;
machine-readable instructions; and
at least one processor circuit to be programmed based on the machine-readable instructions to:
implement a set of application programming interfaces (APIs) to at least one or control or observe a compute chiplet;
select one or more APIs from the set of APIs based on authentication of the management chiplet; and
provide information that identifies the selected one or more APIs to the management chiplet.

26. The apparatus of claim 25, wherein the selected one or more APIs form a subset of approved APIs, and one or more of the at least one processor circuit is to restrict the management chiplet from access to other ones of the APIs not included in the subset of approved APIs.

27-30. (canceled)
